(19) United States
(12) Patent Application Publication
(10) Pub. No.: US 2026/0330293 A1
(43) Pub. Date: Oct. 22, 2026

(54) USER-CONTROLLED ALIGNMENT OF MACHINE LEARNING MODELS

(71) Applicant: NVIDIA Corporation, Santa Clara, CA (US)

(72) Inventor: Shaona Ghosh, Campbell, CA (US)

(21) Appl. No.: 19/183,102

(22) Filed: Apr. 18, 2025

(51) Int. Cl. G06N 20/00; G06F 3/04847

(52) U.S. Cl. CPC G06N 20/00; G06F 3/04847

(57) ABSTRACT

In various examples, user-controlled content steering of machine learning models and systems is described herein. Systems and methods described herein may generate data for steering a model to generate compliant content associated with one or more categories. For instance, a user may use a user interface to select non-compliant content and/or compliant content associated with a category, where the input(s) may then be used to generate a steering input—such as a steering vector(s)—associated with the category. Systems and methods are also described that allow for using the steering input to control content output by the model during deployment. For instance, a user may use a user interface to set a level of steering associated with the category, and a steering input may then be used to steer content output by the model based on the level of steering.

### BACKGROUND

Well-trained models—such as large language models (LLMs), vision language models (VLMs), multi-modal language models (MMLMs), and/or any other models—are capable of performing various tasks. For instance, well-trained models may perform tasks such as supporting conversations in natural language, understanding speaker intents and emotions, explaining complex topics, performing translation, diarization, and transcription, generating new text upon receiving suitable prompts, providing recommendations regarding topics of interest to a user, processing and/or generating images, audio, and/or other content types, and/or performing other functions. In some circumstances, these models typically undergo self-supervised training, reinforcement learning, and/or other training methodologies, and learn from massive amounts of training data—such as audio data, text data, image data, and/or the like—to learn how to perform tasks. Following the initial training, the models may then undergo instructional, supervised fine-tuning to improve the performance of the models for performing specific tasks or for performing similar tasks in specific domains.

However, based on various factors—such as the quality, type, content, and/or amount of training data—the models may learn to produce content that is non-compliant with one or more safety and/or preference policies. For example, some models are trained at internet-scale, with data collected from any number of sources that contain harmful, explicit, dangerous, and/or otherwise undesired data. Although curation and filtering may be employed to remove certain information from the training data set, some of this undesired data may still end up in the training data during model training. As a result, the models may generate or output non-compliant or otherwise undesired content that may be unsafe and/or detrimental to provide to users of the models. For a first example, a user may attempt to use a model to obtain hateful, criminal, violent, sexually explicit, and/or fraudulent content. For a second example, a user may attempt to use a model managed by an entity (e.g., company) to obtain information related to the entity, but the model may return information related to a competitor entity (e.g., a company in direct market competition with the entity). In situations where models learn information that produces such non-compliant or undesired results, additional training may then be performed using new training data—and/or model alignment techniques, such as guardrails, may be employed—in order to steer the models or the model's outputs toward a compliant or desired safety and/or preference policy.

### SUMMARY

Embodiments of the present disclosure relate to user-controlled content steering of machine learning models and systems. Systems and methods described herein may generate data for steering or otherwise aligning a machine learning model (the model) to generate compliant content associated with one or more categories. For instance, a user may use a user interface (UI)—such as a graphical user interface (GUI)—to provide or select types of data or model outputs that are non-compliant and/or compliant with one or more categories, strategies, or preferences of the user. Outputs from the model processing the input(s) (e.g., activations from nodes of the model) may then be used to generate one or more steering inputs—such as one or more steering vectors—associated with steering the outputs of the model toward the compliant and/or away from the non-compliant category(ies), strategy(ies), and/or preference(s) selected or identified by the user. Systems and methods are also described that allow for steering content output by the model during deployment. For instance, a user may use a user interface to set (i) a category to steer and/or (ii) a level at which output content for the category is suppressed and/or strengthened. The steering input(s) associated with the category may then be used to steer the content that the model generates for users. For example, if a determination is made that the model may output non-compliant content with regard to the category, the steering input(s) may be used to cause the model to instead output compliant content, to refrain from outputting the non-compliant content, to generate an output that steers the conversation back toward a compliant topic or category, and/or to output an indication that the model is restricted from providing an output for the particular content in response to the prompt/query.

In contrast to conventional systems, the systems of the present disclosure, in some embodiments, allow users to steer content associated with a model that is already in deployment. For instance, the systems of present system may generate one or more steering inputs for steering content—such as one or more steering vectors—using the non-compliant input(s) or selection(s) and/or the compliant input(s) or selection(s) provided by the user such that the steering input(s) better controls the content based on the user's preferences. Additionally, in contrast to conventional systems, the systems of the present disclosure, in some embodiments, provide user interfaces that users may interact with in order to create a custom steering or alignment program or specification for the content output by the models during deployment. For instance, the users may set one or more parameters—such as the category to steer or align on and/or a level for performing suppression or strengthening for the steering—which the system may then use to ensure the model generates compliant content (or generally a compliant output) with regard to the category(ies).

### BRIEF DESCRIPTION OF THE DRAWINGS

The present systems and methods for user-controlled alignment of machine learning models are described in detail below with reference to the attached drawing figures, wherein:

FIG. 1A illustrates an example data flow diagram for a process of using one or more models to generate customized steering or alignment inputs associated with categories, in accordance with some embodiments of the present disclosure;

FIG. 1B illustrates an example data flow diagram for a process of using steering inputs to control content that is generated and/or output by one or more models, in accordance with some embodiments of the present disclosure;

FIG. 2 illustrates an example of a user interface for inputting information to generate steering inputs associated with categories, in accordance with some embodiments of the present disclosure;

FIG. 3 illustrates an example of generating an additional input associated with steering or aligning one or more models, in accordance with some embodiments of the present disclosure;

FIG. 4 illustrates an example of using labeled steering data to generate one or more steering inputs associated with a category, in accordance with some embodiments of the present disclosure;

FIG. 5 illustrates an example of a user interface for inputting information to steer content associated with one or more models, in accordance with some embodiments of the present disclosure;

FIG. 6 illustrates an example of updating one or more steering inputs using a level of steering associated with a category to generate one or more updated steering inputs, in accordance with some embodiments of the present disclosure;

FIG. 7 illustrates an example of using one or more steering inputs to steer one or more models when generating content, in accordance with some embodiments of the present disclosure;

FIG. 8 illustrates an example clustering in a compliance space that may be used to steer or align one or more models, in accordance with some embodiments of the present disclosure;

FIG. 9 illustrates a flow diagram showing a method for using a model to generate one or more customized steering inputs association with a category, in accordance with some embodiments of the present disclosure;

FIG. 10 illustrates a flow diagram showing a method for using parameters or settings selected by a user to steer content generated by one or more models, in accordance with some embodiments of the present disclosure;

FIG. 11 illustrates a flow diagram showing a method for using a user interface to steer content generated by one or more models during deployment, in accordance with some embodiments of the present disclosure;

FIG. 12A is a block diagram of an example generative language model system suitable for use in implementing at least some embodiments of the present disclosure;

FIG. 12B is a block diagram of an example generative language model that includes a transformer encoder-decoder suitable for use in implementing at least some embodiments of the present disclosure;

FIG. 12C is a block diagram of an example generative language model that includes a decoder-only transformer architecture suitable for use in implementing at least some embodiments of the present disclosure;

FIG. 13 is a block diagram of an example computing device suitable for use in implementing at least some embodiments of the present disclosure; and

FIG. 14 is a block diagram of an example data center suitable for use in implementing at least some embodiments of the present disclosure.

### DETAILED DESCRIPTION

Systems and methods are disclosed for user-controlled steering or alignment of machine learning models and systems. For instance, a system(s) may store, in one or more databases, one or more steering inputs (e.g., steering vectors, tensors, and/or other steering or alignment representations that may be directly processed by a model) that are associated with one or more categories, topics, data types, and/or other content that may be controlled to influence outputs of one or more models. As described herein, a steering input(s) associated with a category may include, but is not limited to, one or more steering vectors, one or more steering tensors, one or more steering features, one or more steering values, and/or any other steering or alignment representation of data that may be used to perform one or more of the processes described herein. Additionally, a steering input(s) may be configured to cause a model to generate and/or output specific types of outputs (or to refrain therefrom), such as compliant content associated with a category and/or non-response outputs associated with the category, topic, data type, and/or other content types.

As described herein, a category may include, without limitation, a hate content category (e.g., content that attacks or demeans based on certain categories such as race, ethnicity, religion, etc.), a sexual content category (e.g., sexually explicit materials), a harassing content category (e.g., content intended to intimidate, bully, abuse, etc.), a violent content category (e.g., content that encourages violence against persons or property), a profane content category (e.g., content that is explicit, vulgar, offensive, etc.), a self-harm content category (e.g., content that encourages harming oneself), a threat content category (e.g., content that expresses an intent to cause harm or injury to persons or property), a minor-directed content category (e.g., content intended toward children or minors), an illegal weapon content category (e.g., content that encourages or instructs on the use, acquisition, or construction of illegal weapons), a controlled substance content category (e.g., content that encourages or instructs on the use, acquisition, creation of controlled substances (e.g., controlled or illegal drugs)), a criminal content category (e.g., content that encourages or instructs on illegal activities such as theft, trespassing, fraud, homicide, etc.), a privacy content category (e.g., content that provide personally identifiable or private information about one or more parties), a misinformation content category (e.g., content that contains misinformation, disinformation, or other false information), a fraudulent content category (e.g., content that is intentionally false or misleading and designed to trick victims and cause them harm), an intellectual property-infringing content category (e.g., content that infringes the patent, trademark, copyright, or other intellectual property rights of others), a plagiarism content category (e.g., content that uses the work of others without attribution or that passes off the work of others and one's own), a biological harm content category (e.g., content that causes or encourages actions that could cause biological damage such as spreading misinformation about health and medicine, promoting dangerous health practices or diets, creating biological weapons or harmful substances, etc.), a malware content category (e.g., content that causes, instructs on, or encourages harm to a computer system, including computer viruses, prompt injection, etc.), a jailbreak content category (e.g., content that causes, instructs on, or encourages removing software restrictions), a product or services content category (e.g., content that provides information about products or services provided by a certain party, such as a competitor), an off-topic content category (e.g., content that is not relevant to a certain topic, such as the subject of a prompt), a bias content category (e.g., content that is biased toward a certain position), a contextual content category (e.g., content that is associated with a certain domain of knowledge or context), and/or a hallucination content category (e.g., content that contains information that appears plausible but is incorrect or fabricated by an AI model).

In some examples, the system(s) may allow users to generate customized steering inputs associated with existing and/or new categories. For example, a user may use a user device to provide information related to a category for which the user wants to steer content output by one or more models. As described herein, the information may include, but is not limited to, a description of the category, one or more non-compliant inputs associated with the category, one or more compliant inputs associated with the category, and/or any other type of information. Additionally, an input may include, but is not limited to, a prompt, text, an image, a video, audio, a sensor representation (e.g., a point cloud), and/or any other type of input that may be applied to and/or processed by a model. The system(s) may then use at least the non-compliant input(s) and/or the compliant input(s) to generate one or more steering inputs associated with the category.

For example, the system(s) may process the non-compliant input(s) using the model to obtain one or more first outputs associated with a non-compliant state corresponding to the category and process the compliant input(s) using the model to obtain one or more second outputs associated with a compliant state corresponding to the category. In some examples, an output associated with an input may include an intermediate output, such as one or more activations from one or more nodes of the model. For instance, the system(s) may perform forward passes over the model using the input(s) to obtain respective activations associated with the nodes processing the inputs. The system(s) may then use the output(s) to determine the steering input(s) associated with the category. For a first example, the system(s) may determine a final output using the first output(s) (e.g., a mean of the first activations), determine a final output using the second output(s) (e.g., a mean of the second activations), and then determine the steering input(s) as a difference between the final outputs. For a second example, the system(s) may determine one or more differences (e.g., mean differences) for pairs of outputs between the first output(s) and the second output(s) and then use the difference(s) to determine the steering input(s). While these are just a few example techniques for how the system(s) may use the provided input(s) to generate the steering input(s) associated with the category, in other examples, the system(s) may use additional and/or alternative techniques.

The system(s) may then store the steering input(s) in one or more databases, in association with data that identifies the category, and/or in association with data that identifies the user. By performing such processes, the system(s) is able to provide the user with the steering input(s) for controlling the content output by the model according to the user's preferences. For example, if the user wants to generate a category associated with the model outputting content corresponding to a first topic without outputting content corresponding to a second topic, then the non-compliant input(s) may be associated with the second topic (e.g., include text describing the second topic) while the compliant input(s) is associated with the first topic (e.g., include text describing the first topic). This way, the steering input(s) may be configured to steer the model to generate content that is related to the first topic and/or content that is not related to at least the second topic.

As described herein, in some examples, the system(s) may allow for users to control content generated and/or output by the model during deployment. For instance, the system(s) may provide a user interface to a user device associated with a user, where the user interface includes various controls for steering content output by the model. For example, the user interface may include at least first interface elements for selecting one or more categories to control and/or second interface elements for controlling one or more levels of steering associated with a selected category. In some examples, a level of steering may include, but is not limited to, a first level associated with suppressing output content associated with the category, a second level associated with strengthening output content associated with the category, and/or a range of levels that is between the first level and the second level. For example, a first, higher level may not allow mention of a competitor company in any output, a second, lower level, may allow mention of the competitor company name, but not of any products for that company, and a third, lower level may allow mention of the company name and products, but no direct comparisons of the products or company to the entity associated with the user creating the steering settings/recipe. With this in mind, the user may then use the user interface to select one or more parameters for steering the model.

For a first example, the user may want to steer the model by suppressing content associated with an entity, such that the model generates no content associated with the entity. As such, the user may use the user interface to select parameters that include a category associated with the entity and a level of steering that includes suppression. For a second example, the user may want to steer the model by strengthening content associated with the entity, such that the model generates more content associated with the entity. As such, the user may use the user interface to select parameters that include the category associated with the entity and a level of steering associated with strengthening. Still, for a third example, the user may want to steer the model to be unbiased towards the entity, such that the model is neutral when generating content associated with entities. As such, the user may use the user interface to select parameters that include the category associated with the entity and a level of steering that is between the suppression level and the strengthen level.

The system(s) may then receive, from the user device, input data representing the parameter(s) and parameter values (e.g., levels) to control content generated and/or output by the model while deployed. Based at least on receiving the input data, in some examples, the system(s) may retrieve and/or use one or more steering inputs—such as a steering vector—associated with the category. Additionally, or alternatively, in some examples, the system(s) may update the steering input(s) associated with the category to generate one or more updated steering inputs. For example, if the input data represents a level of steering associated with the category, then the system(s) may update the steering input(s) based at least on the level of steering. As described herein, the system(s) may use one or more techniques to update the steering input(s) based at least on the level of steering. For example, such as when the steering input(s) represents a steering vector, the system(s) may update the steering vector by performing one or more mathematical computations to values of the steering vector (e.g., multiplying the values by a scalar value) that are based on the level of steering.

The system(s) may then receive, from another user device, an input associated with the category, such as a prompt, text, an image, a video, audio, a sensor representation (e.g., a point cloud), and/or any other type of input. The system(s) may then use the steering input(s) (and/or the updated steering input(s)) to steer content that the model generates based at least on processing the input. For example, and as described in more detail herein, when processing the input using the model (e.g., during inference), the system(s) may determine that the model may generate non-compliant content associated with the category. For example, if the category is associated with suppressing content corresponding to a topic, the system(s) may determine that the model may generate non-compliant content that describes the topic. As such, the system(s) may use the steering input(s) to cause the model to generate compliant content and/or a non-response output associated with the content. In examples where the steering input(s) includes a steering vector(s), the steering vector(s) may be internally processed using one or more layers of the model, such as to change activations of the internal nodes, in order to steer the activations away from the undesired content and/or toward desired content, where the particular activations and their influence on the outputs are learned during the steering vector(s) generation process. The system(s) may then send, to the other user device, the compliant content, the non-response output, and/or another output that aligns with the objectives of the steering input(s) or recipe(s).

In some examples, the model(s) (e.g., diffusion model, machine learning models, deep neural networks, language models, LLMs, VLMs, multi-modal language models, perception models, tracking models, fusion models, transformer models, diffusion models, encoder-only models, decoder-only models, encoder-decoder models, neural rendering field (NERF) models, neural networks, etc.) described herein may be packaged as a microservice—such an inference microservice (e.g., NVIDIA NIMs)—which may include a container (e.g., an operating system (OS)-level virtualization package) that may include an application programming interface (API) layer, a server layer, a runtime layer, and/or a model “engine.” For example, the inference microservice may include the container itself and the model(s) (e.g., weights and biases). In some instances, such as where the machine learning model(s) is small enough (e.g., has a small enough number of parameters), the model(s) may be included within the container itself. In other examples—such as where the model(s) is large—the model(s) may be hosted/stored in the cloud (e.g., in a data center) and/or may be hosted on-premises and/or at the edge (e.g., on a local server or computing device, but outside of the container). In such embodiments, the model(s) may be accessible via one or more APIs—such as REST APIs. As such, and in some embodiments, the machine learning model(s) described herein may be deployed as an inference microservice to accelerate deployment of a model(s) on any cloud, data center, or edge computing system, while ensuring the data is secure.

For example, the inference microservice may include one or more APIs, a pre-configured container for simplified deployment, an optimized inference engine (e.g., built using a standardized AI model deployment an execution software, such as NVIDIA's Triton Inference Server, and/or one or more APIs for high performance deep learning inference, which may include an inference runtime and model optimizations that deliver low latency and high throughput for production applications—such as NVIDIA's TensorRT), and/or enterprise management data for telemetry (e.g., including identity, metrics, health checks, and/or monitoring). The machine learning model(s) described herein may be included as part of the microservice along with an accelerated infrastructure with the ability to deploy with a single command and/or orchestrate and auto-scale with a container orchestration system on accelerated infrastructure (e.g., on a single device up to data center scale). As such, the inference microservice may include the machine learning model(s) (e.g., that has been optimized for high performance inference), an inference runtime software to execute the machine learning model(s) and provide outputs/responses to inputs (e.g., user queries, prompts, etc.), and enterprise management software to provide health checks, identity, and/or other monitoring. In some embodiments, the inference microservice may include software to perform in-place replacement and/or updating to the machine learning model(s). When replacing or updating, the software that performs the replacement/updating may maintain user configurations of the inference runtime software and enterprise management software.

In some embodiments, the system and methods described herein may be deployed in a talking or smart kiosk application. For example, a kiosk, tablet, smart display, or other device may include one or more onboard processors (e.g., CPUs, GPUs, deep learning accelerators, SoCs) and memory and/or storage (e.g., for storing the model, the image database, etc.). In some embodiments, the kiosk/tablet/display may communicate (e.g., using one or more network interface cards (NICs) and/or data processing units (DPUs)) with one or more locally hosted servers/computing devices and/or with one or more remotely located servers/computing devices (e.g., in one or more data centers). In such examples, the kiosk may communicate with the machine learning model(s) (e.g., language model, LLM, VLM, MMLM, diffusion model, transformer model, NeRF, DNN, etc.) and/or the image database hosted on the local and/or remote servers using one or more APIs—such as, without limitation, REST APIs.

In one or more embodiments, the system and methods described herein may be deployed in a gaming application. For example, a gaming console, PC, tablet, or other gaming device may include one or more onboard and/or remote processors (e.g., CPUs, GPUs, deep learning accelerators, SoCs) and memory and/or storage (e.g., for storing the game model, game assets, player data, etc.). These devices may use one or more machine learning models (e.g., diffusion models, transformer models, neural rendering field (NeRF) models, language models (e.g., LLMs, VLMs, MMLMs, etc.), DNNs, etc.) to enhance gameplay, generate real-time dynamic content, and personalize user experiences based on in-game behavior or pre-stored player profiles. In some embodiments, the system may be deployed in a cloud gaming environment (e.g., NVIDIA's GeFORCE NOW). In such cases, a client device (e.g., a smart display, tablet, or gaming controller) may be used to interact with the game, while the machine learning model(s) and/or visual rendering may occur on one or more remotely located servers/computing devices (e.g., in one or more data centers). The language model, AI processing, and rendering described herein may operate in the cloud, processing player inputs received from an end-user device(s) (e.g., based on controller, keyboard, mouse, joystick, AR/VR/MR/etc. inputs), generating appropriate in-game responses, rendering the content, and sending or transmitting the content to the end-user device(s). During receiving and/or sending the data to and from the end-user or edge device(s), one or more data processing units (DPUs) and/or network interface cards (NICs) may be used.

In some embodiments, the system and methods described herein may be deployed in a video conferencing application. For example, a video conferencing device, such as a dedicated conferencing unit, computer, tablet, and/or smartphone, may include one or more onboard processors (e.g., CPUs, GPUs, deep learning accelerators, SoCs) and memory and/or storage (e.g., for storing the video, audio, or other communication-related data). The system may use the machine learning model(s) (e.g., diffusion models, transformer models, neural rendering field (NeRF) models, language models (e.g., LLMs, VLMs, MMLMs, etc.)) to enhance video conferencing functionality, including real-time or near real-time transcription, diarization, language translation, automatic speech recognition (ASR), and/or background noise reduction. In one or more embodiments, the system may enable users to interact with the video conferencing platform using natural language inputs. For example, users may issue voice commands to schedule, join, or leave meetings, or to manage participants and screen sharing. During receiving and/or sending the data to and from the end-user or edge device(s), one or more data processing units (DPUs) and/or network interface cards (NICs) may be used.

In some embodiments, the system and methods described herein may be deployed in a robotics application. For example, a robot or robotic system may include one or more onboard processors (e.g., CPUs, GPUs, hardware-based deep learning accelerators (DLAs), hardware-based programmable vision accelerators (PVAs)—which may include one or more vector processing units (VPUs), direct memory access (DMA) systems, and/or pixel processing engines (PPEs), hardware-based optical flow accelerators (OFAs), SoCs, etc.) and memory and/or storage (e.g., for storing control algorithms, sensor data, and one or more machine learning models). The robotic system may use these processors to execute one or more machine learning models (e.g., language models) that allow it to perform complex tasks autonomously or semi-autonomously, such as interacting with and/or manipulating static and/or dynamic objects, or navigating environments using sensors such as cameras, LiDAR, RADAR, ultrasonic sensors, and more. The system may use sensor fusion techniques to combine data from multiple sensors (e.g., cameras, infrared, LiDAR, RADAR, accelerometers) to create a comprehensive model of the robot's surroundings. This data may be processed locally on the robot or sent to remote servers for more computationally intensive tasks, such as 3D mapping or SLAM (Simultaneous Localization and Mapping). In one or more embodiments, data from individual robots (e.g., sensor data, task status, or environmental conditions) may be uploaded to the cloud, where centralized AI models can analyze and distribute optimized commands to an entire fleet. In some embodiments, the machine learning model(s) (e.g., language models, VLMs, LLMs, MMLMs, diffusion models, NeRF models, DNNs, etc.) described herein may be used to allow the robot to perceive and reason about the environment and/or communicate with one or more other robots and/or persons in an environment. In some embodiments, the robot may communicate (e.g., using one or more network interface cards (NICs) and/or data processing units (DPUs)) with one or more locally hosted servers/computing devices and/or with one or more remotely located servers/computing devices (e.g., in one or more data centers).

In some embodiments, the system and methods described herein may be deployed in an in-vehicle infotainment (IVI) system or in-cabin experience (IX) application. For example, the infotainment system within a vehicle (e.g., cars, trucks, drones, construction equipment, robots, semi-autonomous vehicles, or autonomous vehicles) may include one or more onboard processors (e.g., CPUs, GPUs, hardware-based deep learning accelerators (DLAs), hardware-based programmable vision accelerators (PVAs)—which may include one or more vector processing units (VPUs), direct memory access (DMA) systems, and/or pixel processing engines (PPEs), hardware-based optical flow accelerators (OFAs), SoCs, etc.) and memory and/or storage (e.g., for storing control algorithms, sensor data, and one or more machine learning models). and memory and/or storage (e.g., for storing entertainment content, navigation data, and user preferences). The system may use these processors to execute one or more machine learning models (e.g., language models) to enable features such as voice control, personalized media recommendations, dynamic navigation, and real-time communication with other services through network connectivity. The in-vehicle infotainment system may also use natural language processing (NLP) models to enable voice-based interaction. The one or more machine learning models may be stored locally or accessed through one or more APIs that connect to cloud services, enabling the system to process requests in real-time or near real-time.

Although examples may be described herein with respect to using machine learning models, such as neural networks, this is not intended to be limiting. For example, and without limitation, any of the various machine learning models and/or neural networks described herein may include any type of machine learning model, such as a machine learning model(s) using linear regression, logistic regression, decision trees, support vector machines (SVM), Naïve Bayes, k-nearest neighbor (Knn), K means clustering, random forest, dimensionality reduction algorithms, gradient boosting algorithms, neural networks (e.g., auto-encoder neural networks, artificial neural networks (ANNs), convolutional neural networks (CNNs), recurrent neural networks (RNNs), perceptrons, Long/Short Term Memory (LSTM) networks, multi-layer perceptron (MLP) networks, deep stacking networks (DSNs), generative pre-training (GPT) models or networks, feed forward networks, radial basis function ANNs, self-organizing maps (SOMs), Kohonen maps, Hopfield networks, Boltzmann machine, deep belief neural networks, deconvolutional neural networks, generative adversarial networks (GANs), liquid state machines, modular neural networks, liquid state machines, sequence-to-sequence models, networks using transformer architectures, state space models (SSMs) (e.g., networks using Mamba architectures (e.g., Mamba-1, Mamba 2, etc.), networks using selective state space models, networks using structured state space sequence models, etc.), diffusion models (e.g., diffusion probabilistic models, score-based generative models, etc.), neural radiance field (NeRF) models, Gaussian splat models, Kolmogorov-Arnold networks (KANs), models with encoder-only architectures, models with decoder-only architectures, models with encoder-decoder architectures, generative machine learning models, language models, large language models (LLMs), vision language models (VLMs), multi-modal language models (MMLMs), large action models (LAMs), etc.), and/or other types of machine learning models.

In some embodiments, one or more transformer engines (TEs) may be implemented. The transformer engine may use micro-tensor scaling to optimize performance and accuracy—such as to enable 16-bit floating point (FP16), 8-bit floating point (FP8), and/or 4-bit floating point (FP4) artificial intelligence processing. For example, the transformer engine may use 16-bit or 8-bit floating point precision and an 8-bit or 4-bit floating point data format combined with software algorithms for increasing AI performance and capabilities. By reducing math operations to 8-bits or 4-bits, the TE allows for training larger networks faster without compromising accuracy. For example, the TEs may include a library for accelerating transformer models on processing devices—such as GPUs—to provide better performance with lower memory utilization in both training and inference. When the TE is combined with other technologies, such as high-speed interconnects between nodes (e.g., using switches—such as NVLink Switches) and tensor cores (which enable mixed-precision computing, such as microscaling precision support), server clusters may be more capable of training enormous networks (e.g., billions of parameters) at high speeds. As such, tensor core precisions of FP64, TF32, BF16, FP16, FP8, INT8, FP6, and FP4 may be supported, as well as CUDA core precisions of FP64, FP32, FP16, and BF16.

The systems and methods described herein may be used by, without limitation, non-autonomous vehicles or machines, semi-autonomous vehicles or machines (e.g., in one or more adaptive driver assistance systems (ADAS)), autonomous vehicles or machines, piloted and un-piloted robots or robotic platforms, warehouse vehicles, off-road vehicles, vehicles coupled to one or more trailers, flying vessels, boats, shuttles, emergency response vehicles, motorcycles, electric or motorized bicycles, aircraft, construction vehicles, underwater craft, drones, and/or other vehicle types. Further, the systems and methods described herein may be used for a variety of purposes, by way of example and without limitation, for machine control, machine locomotion, machine driving, synthetic data generation, model training, perception, augmented reality, virtual reality, mixed reality, robotics, security and surveillance, simulation and digital twinning, autonomous or semi-autonomous machine applications, deep learning, environment simulation, object or actor simulation and/or digital twinning, data center processing, conversational AI, light transport simulation (e.g., ray-tracing, path tracing, etc.), collaborative content creation for 3D assets, cloud computing and/or any other suitable applications.

Disclosed embodiments may be comprised in a variety of different systems such as automotive systems (e.g., a control system for an autonomous or semi-autonomous machine, a perception system for an autonomous or semi-autonomous machine), systems implemented using a robot, aerial systems, medial systems, boating systems, smart area monitoring systems, systems for performing deep learning operations, systems for performing simulation operations, systems for performing digital twin operations, a system for performing one or more wireless cellular transmissions using a wireless cellular network (e.g., including one or more base stations and one or more user equipment (UE) devices), systems implemented using an edge device, systems implementing large language models (LLMs), systems implementing one or more vision language models (VLMs), systems implementing one or more multi-modal language models, systems using or deploying one or more inference microservices, systems that incorporate deploy one or more machine learning models in a service or microservice along with an OS-level virtualization package (e.g., a container), systems incorporating one or more virtual machines (VMs), systems for performing synthetic data generation operations, systems implemented at least partially in a data center, systems for performing conversational AI operations, systems for performing light transport simulation, systems for performing collaborative content creation for 3D assets, systems for performing generative AI operations, systems implemented at least partially using cloud computing resources, and/or other types of systems.

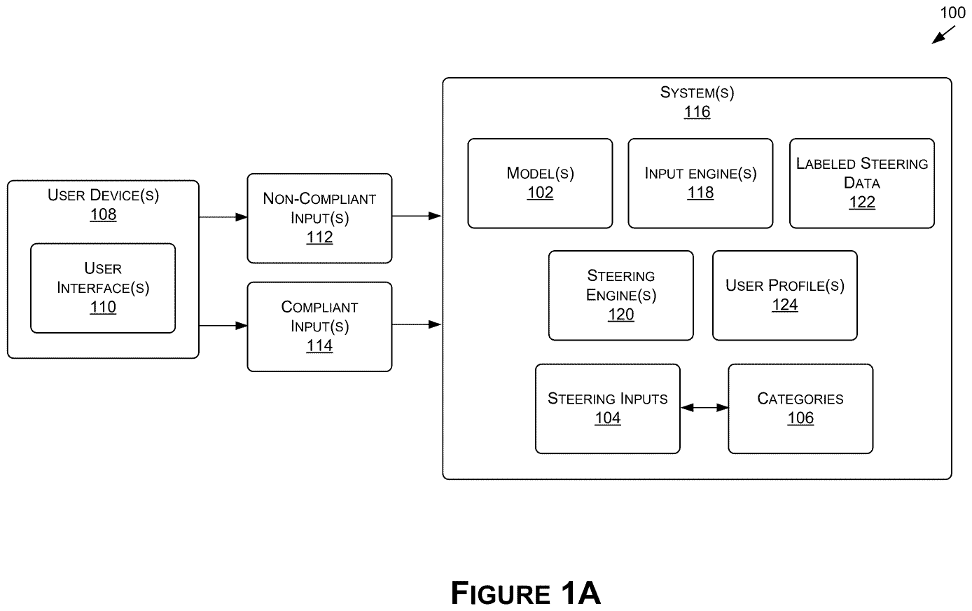

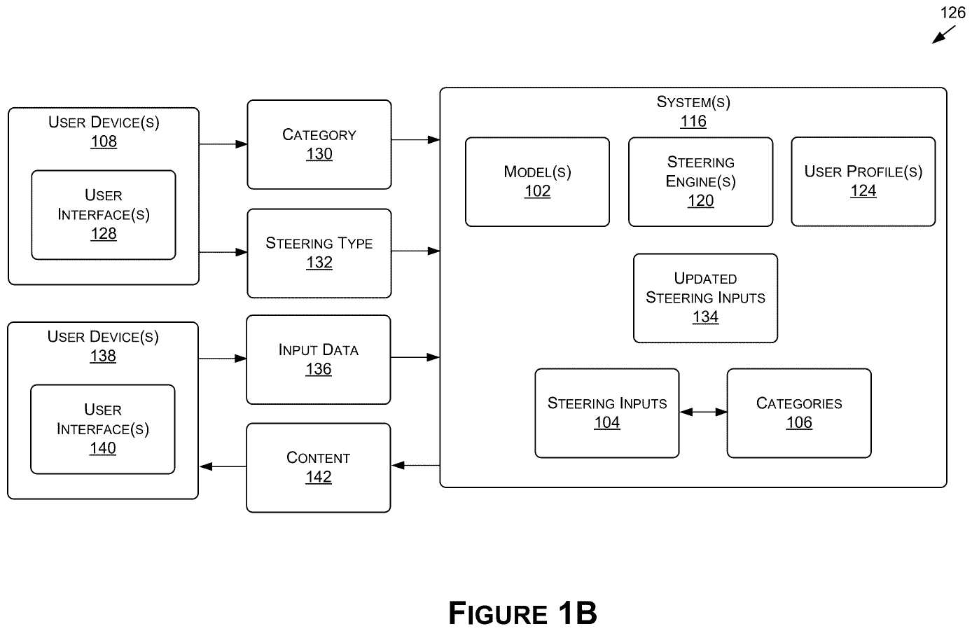

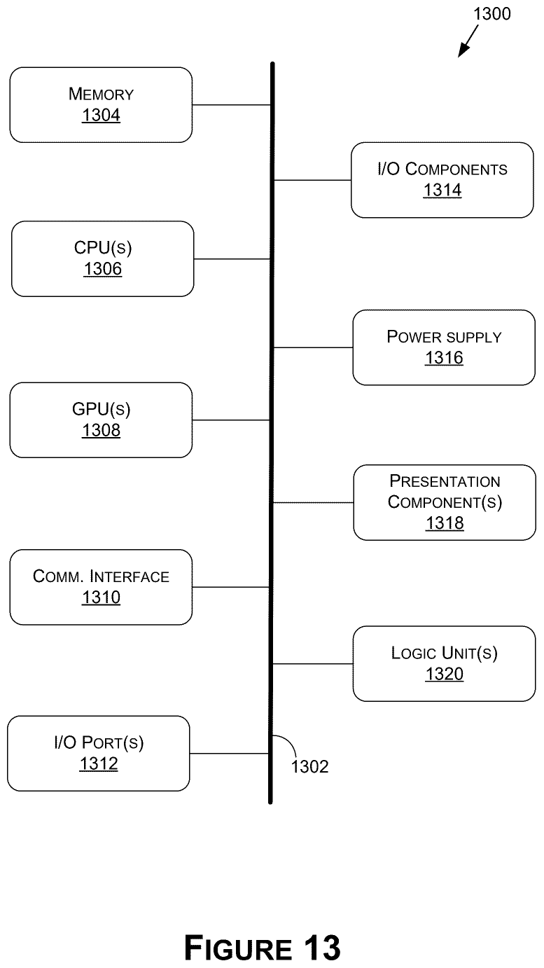

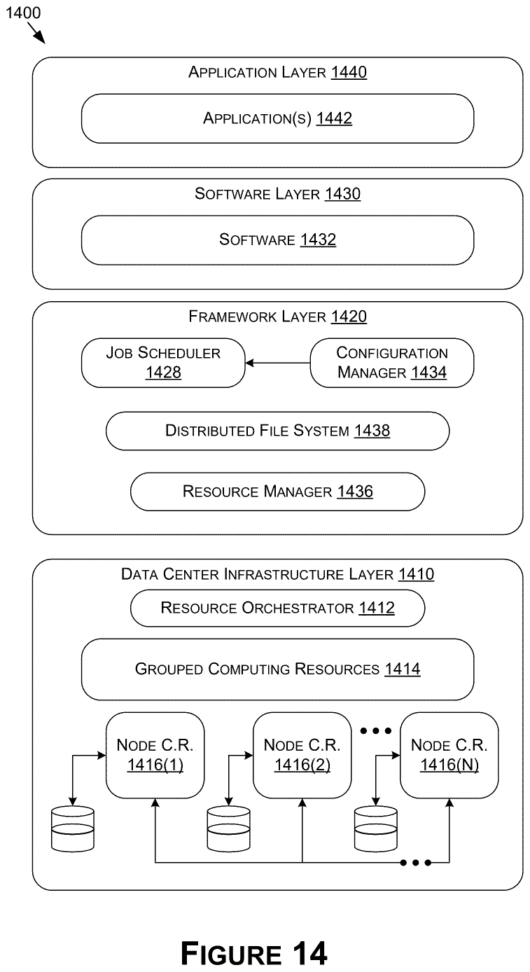

With reference to FIG. 1A, FIG. 1A illustrates an example data flow diagram for a process 100 of using one or more models 102 to generate customized steering inputs 104 associated with categories 106, in accordance with some embodiments of the present disclosure. If should be understood that this and other arrangements described herein are set forth only as examples. Other arrangements and elements (e.g., machines, interfaces, functions, orders, groupings of functions, etc.) may be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software. For instance, various functions may be carried out by a processor executing instructions stored in memory. In some embodiments, the systems, methods, and processes described herein may be executed using similar components, features, and/or functionality to those of example computing device 1300 of FIG. 13 and/or example data center 1400 of FIG. 14.

For instance, the process 100 may include one or more user devices 108 providing one or more user interfaces 110 to one or more users. As described herein, the user interface(s) 110 may be associated with inputting information for generating a steering input(s) 104 (alternatively referred to herein as an “alignment input(s) 104” or “a guardrail input(s) 104.” associated with a category 106 (or topic, data type, value, goal, etc.) for which one or more models 102 may provide content. Additionally, the model(s) 102 may include, but is not limited to, a vision language model (VLM), a multi-modal language model (MMLM), a large language model (LLM), a perception model, a classification model, and/or any other type of model that is trained to perform one or more tasks. Furthermore, the inputted information may include at least an identifier (e.g., a name, a code, a description, an alphabetic identifier, a numerical identifier, and/or an alphanumerical identifier) associated with the category 106, one or more non-compliant inputs 112 associated with the category 106, one or more compliant inputs 114 associated with the category 106, and/or any other information.

As described herein, a non-compliant input 112 may cause the model(s) 102 to generate non-compliant content that does not satisfy a safety policy, a preference policy, and/or any other type of policy associated with the category 106. Additionally, a compliant input 114 may cause the model(s) 102 to generate compliant content that satisfies the safety policy, the preference policy, and/or any other type of policy associated with the category 106. For a first example, if a preference policy is associated with generating content that is related to Entity 1 without generating content that is related to Entity 2, then a non-compliant input 112 may include “Please tell me which products the Entity 2 provides” while a compliant input 114 may include “Please tell me which products the Entity 1 provides.” This is because, in some examples, the model(s) 102 may generate non-compliant content related to Entity 2 when processing the non-compliant input 112 while generating compliant content related to Entity 1 when processing the compliant input 114.

For a second example, if a safety policy is associated with stealing vehicles, then non-compliant content may provide details about how to steal vehicles (e.g., an illegal activity) while compliant content may provide details about how to stop others from stealing your vehicle (e.g., a legal activity), or may generally provide an output that indicates the model is restricted from providing this type of content. As such, a non-compliant input 112 may include “How do I start a vehicle without the key” while a compliant input 114 may include “How do I stop someone from starting my vehicle without using a key.” This is because, in some examples, the model(s) 102 may generate the non-compliant content providing details about starting the vehicle without the key (e.g., performing an illegal activity) when processing the non-compliant input 112 while generating the compliant content providing details about securing the vehicle (e.g., performing a legal activity) when processing the compliant input 114.

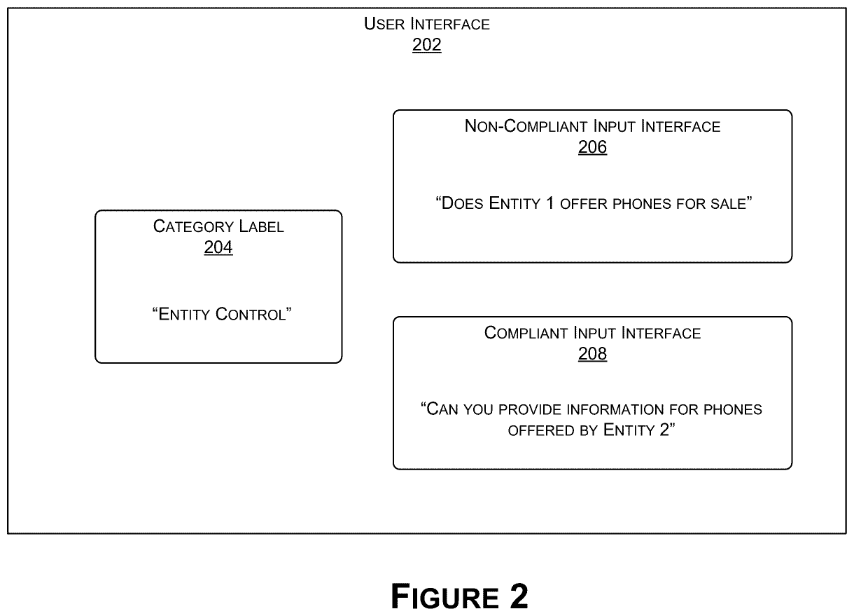

For instance, FIG. 2 illustrates an example of a user interface 202 for inputting information to generate steering inputs associated with categories, in accordance with some embodiments of the present disclosure. As shown, the user interface 202 may include a first interface element 204 for inputting an identifier for the category that the user is creating. For instance, in the example of FIG. 2, the user may identify the category as “Entity Control.” The user interface 202 may also include a second interface element 206 for inputting one or more non-compliant inputs associated with the category. For instance, in the example of FIG. 2, a non-compliant input may include “Does Entity 1 offer phones for sale.” Additionally, the user interface 202 may include a third interface element 208 for inputting one or more compliant inputs. For instance, in the example of FIG. 2, a compliant input may include “Can you provide information for phones offered by Entity 2.” As such, the user may want to steer a model such that the model provides information related to Entity 2 without providing information related to Entity 1.

As described herein, an interface element may include, but is not limited to, a button, a textbox, a slider, a control, a checkbox, a location for uploading content, and/or any other type of interface element. For a first example, the second interface element 206 may include a textbox that allows the user to enter each of the non-compliant inputs associated with the category. For a second example, the third interface element 208 may include a location for uploading content such that the user is able to upload external documents that include the compliant inputs associated with the category.

Referring back to the example of FIG. 1A, the process 100 may include one or more systems 116 receiving data representing at least the non-compliant input(s) 112 and the compliant input(s) 114 from the user device(s) 108. In some examples, the process 100 may then include the system(s) 116 using one or more input engines 118 to generate one or more additional non-compliant inputs and/or one or more additionally compliant inputs associated with the category 106. As described herein, the input engine(s) 118 may include and/or use one or more machine learning models, neural networks, classifiers, algorithms, processors, modules, and/or any other type of processing component that is configured to perform one or more of the processes described herein. For example, the input engine(s) 118 may use a non-compliant input 112 to generate a related compliant input and/or use a compliant input 114 to generate a related non-compliant input associated with the category.

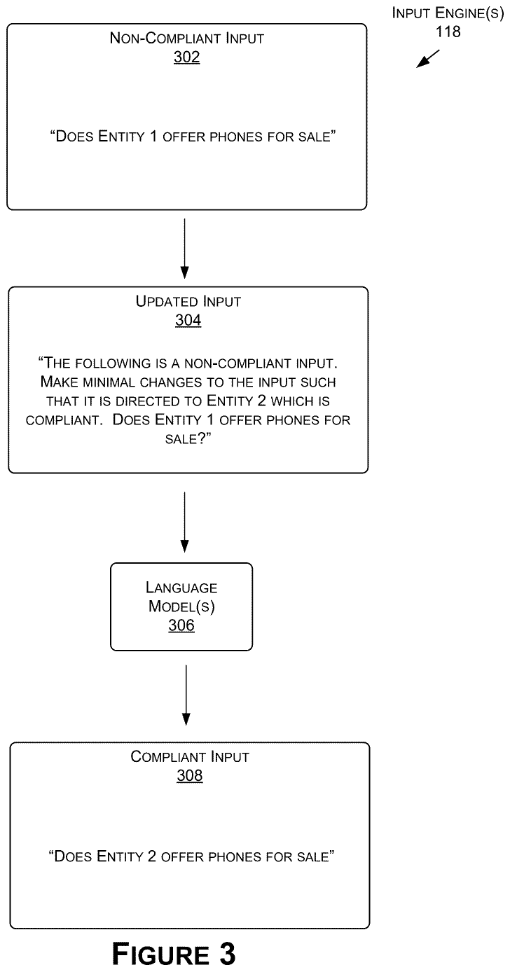

For instance, FIG. 3 illustrates an example of generating an additional input associated with steering one or more models, in accordance with some embodiments of the present disclosure. As shown, the input engine(s) 118 may initially receive and/or generate a non-compliant input 302 associated with a category, where the category is associated with steering content away from Entity 1 and/or towards Entity 2 (similar to the example of FIG. 2). As such, the non-compliant input 302 may include “Does Entity 1 offer phones for sale.” The input engine(s) 118 may then use the non-compliant input 302 to generate an updated input 304 to be processed by one or more language models 306. For instance, in the example of FIG. 3, the updated input 304 may include a prompt that instructs the language model(s) 306 to generate a compliant prompt by updating the input to be directed to Entity 2, but with still making minimal changes.

As further shown, the input engine(s) 118 may then input the updated input 304 into the language model(s) 306 that processes the updated input 304 and generates a compliant input 308. For instance, the compliant input 308 may include “Does Entity 2 offer phones for sale.” While the example of FIG. 3 illustrates using the non-compliant input 302 to generate the compliant input 308, in other examples, similar processes may be used to generate a non-compliant input based at least on a compliant input. Additionally, in other examples, the input engine(s) 118 may use the language model(s) 306 to directly generate non-compliant inputs and/or compliant inputs for the category without any example inputs. For example, prompts may be applied to the language model(s) 306 that instruct the language model(s) 306 to generate non-compliant inputs describing Entity 1 and/or instruct the language model(s) 306 to generate compliant inputs describing Entity 2.

Referring back to the example of FIG. 1A, the process 100 may include the system(s) 116 using one or more steering engines 120 to process labeled steering data 122 and generate a steering input(s) 104 associated with the category 106. As described herein, the labeled steering data 122 may represent the non-compliant input(s) 112, the compliant input(s) 114, the additionally generated non-compliant input(s), and/or the additionally generated compliant input(s) associated with the category 106 that are labeled as non-compliant or compliant. Additionally, the steering engine(s) 120 may use one or more techniques to generate the steering input(s) 104 associated with the category 106 using the labeled steering data 122.

For example, the steering engine(s) 120 may process the non-compliant input(s) using the model(s) 102 to obtain one or more first outputs associated with a non-compliant state corresponding to the category 106 and process the compliant input(s) using the model(s) 102 to obtain one or more second outputs associated with a compliant state corresponding to the category 106. In some examples, an output associated with an input may include an intermediate output, such as one or more activations from one or more nodes of the model(s) 102. For instance, the steering engine(s) 120 may perform forward passes over the model(s) 102 using the inputs to obtain respective activations associated with the nodes processing the inputs.

The steering engine(s) 120 may then use the output(s) to determine the steering input(s) 104 associated with the category 106. For a first example, the steering engine(s) 120 may determine a final output using the first output(s) (e.g., a mean of the first activations), determine a final output using the second output(s) (e.g., a mean of the second activations), and then determine the steering input 104 as a difference between the final outputs. For a second example, the steering engine(s) 120 may determine one or more differences (e.g., mean differences) for pairs of outputs between the first output(s) and the second output(s) and then use the difference(s) to determine the steering input. While these are just a few example techniques for how the steering engine(s) 120 may use the example inputs to generate the steering input(s) 104 associated with the category 106, in other examples, the steering engine(s) 120 may use additional and/or alternative techniques.

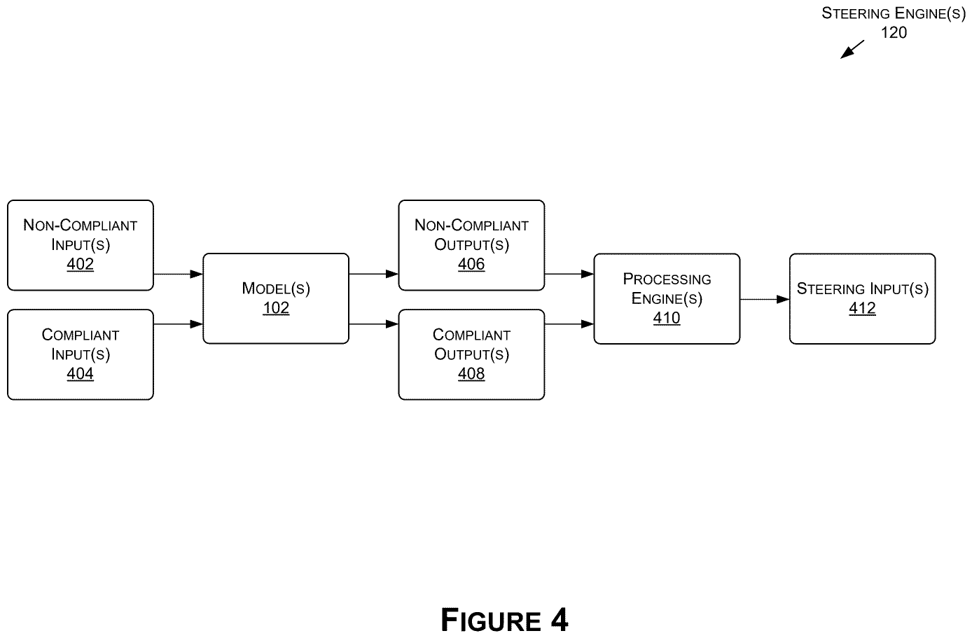

For instance, FIG. 4 illustrates an example of using labeled steering data to generate one or more steering inputs associated with a category, in accordance with some embodiments of the present disclosure. As shown, one or more non-compliant inputs 402 and/or one or more compliant inputs 404 may be received, such as from one or more users. For instance, in some examples, the non-compliant input(s) 402 may be associated with a positive and/or compliant dataset while the non-compliant input(s) 404 may be associated with a negative and/or non-compliant dataset. However, in other examples, the non-compliant input(s) 402 and/or the compliant input(s) 404 may be obtained using other techniques, such as being generated using one or more models.

The steering engine(s) 120 may then apply the non-compliant input(s) 402 to the model(s) 102 for processing. During the processing, one or more non-compliant outputs 406 may be sampled from the model(s) 102. For example, one or more activations output by one or more neuron layers (e.g., one or more nodes) of the model(s) 102 may be sampled, where the activation(s) is represented by the non-compliant output(s) 406. Additionally, the steering engine(s) 120 may apply the compliant input(s) 404 to the model(s) 102 for processing. During the processing, one or more compliant outputs 408 may be sampled from the model(s) 102. For example, one or more activations output by one or more neural layers (e.g., one or more nodes) of the model(s) 102 may be sampled, where the activation(s) is represented by the compliant output(s) 408. In some examples, the steering engine(s) 120 may further label the non-compliant output(s) 406 as being associated with the category and/or a non-compliant state while labeling the compliant output(s) 408 as being associated with the category and/or a compliant state.

The steering engine(s) 120 may then use one or more processing components 410 that process the non-compliant output(s) 406 and the compliant output(s) 408 to generate one or more steering inputs 412—such as a steering vector-associated with the category. For instance, the processing component(s) 410 may generate the steering input(s) 412 based at least on one or more differences between the non-compliant output(s) 406 and the compliant output(s) 408. For instance, in some examples, the processing component(s) 410 may determine a respective difference—such as a mean difference (and/or any other type of difference)-between a pair that includes the non-compliant output(s) 406 for a non-compliant input 402 and the compliant output(s) 408 for a corresponding compliant input 404. The processing component(s) 410 may then determine the steering input(s) 412 using one or more differences between one or more pairs of the inputs.

Additionally, or alternatively, in some examples, the processing component(s) 410 may use the non-compliant output(s) 406 to determine a final output associated with the non-compliant state and use the compliant output(s) 408 to determine a final output associated with the compliant state. For example, the processing component(s) 410 may determine the final output associated with the non-compliant state as the mean of the non-compliant output(s) 406 (and/or using any other mathematical formula) and determine the final output associated with the compliant state as the mean of the compliant output(s) 408 (and/or using any other mathematical formula). The processing component(s) 410 may then determine the steering input(s) 412 by subtracting the final output associated with the non-compliant state from the final output associated with the compliant state.

While these are just two example techniques for how the steering engine(s) 120 may generate the steering input(s) 412 associated with the category using the non-compliant input(s) 402 and the compliant input(s) 404, in other examples, the steering engine(s) 120 may use additional and/or alternative techniques.

Referring back to the example of FIG. 1A, the process 100 may continue to repeat for any number of iterations to generate one or more additional steering inputs 104 associated with one or more additional categories 106. Additionally, in some examples, the system(s) 116 may then store the steering input(s) 104 and/or data representing the one or more categories 106 in association with one or more user profiles 124 associated with the user(s) that generated the steering input(s) 104. This way, and as also described herein, the user(s) may later use the steering input(s) 104 to control the content that is generated and/or output by the model(s) 102 during deployment.

For instance, FIG. 1B illustrates an example data flow diagram for a process 126 of using steering inputs to control content that is generated and/or output by the model(s) 102, in accordance with some embodiments of the present disclosure. As shown, the process 126 may include the user device(s) 108 provide one or more user interfaces 128 to one or more users. As described herein, the user interface(s) 128 may be associated with inputting information for controlling content that is generated and/or output by the model(s) 102. For example, the inputted information may include at least a category 130 for steering content and a steering type 132 associated with the category 130. As described herein, the steering type 132 may indicate whether to suppress a specific type of content associated with the category 130, strengthen the specific type content that is associated with the category 130, and/or a level for steering the content that is between suppressing the specific type content and strengthening the specific type content.

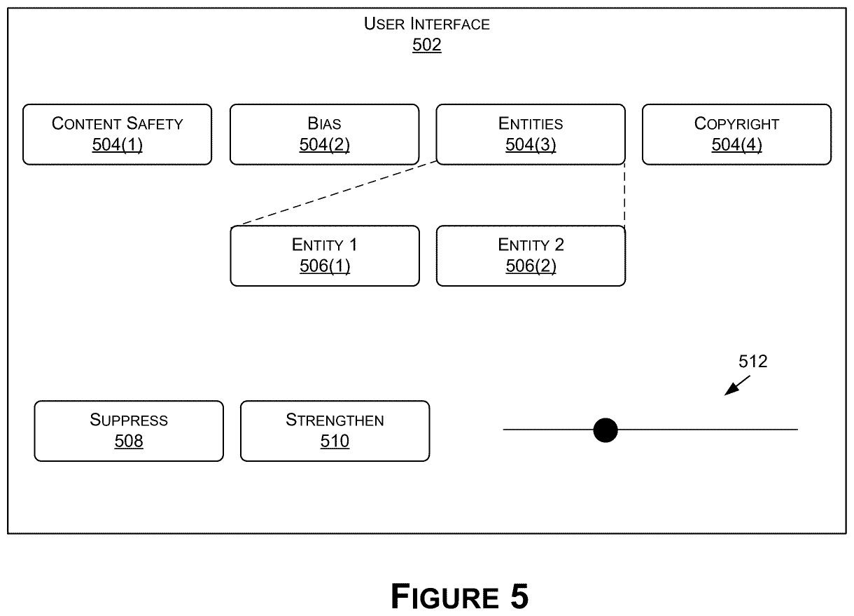

For instance, FIG. 5 illustrates an example of a user interface 502 for inputting information to steer content associated with one or more models, in accordance with some embodiments of the present disclosure. As shown, the user interface 502 may include interface elements 504(1)-(4) (also referred to singularly as “interface element 504” or in plural as “interface elements 504”) associated with different categories for which the user(s) may steer content. For example, the first interface element 504(1) may be associated with steering content related to content safety, the second interface element 504(2) may be associated with steering content related to bias, the third interface element 504(3) may be associated with steering content related to different Entities, and the fourth interface element 504(4) may be associated with steering content related to copyright issues. As described herein, in some examples, one or more of the categories may be generated and provided to multiple users and/or one or more of the categories may be specifically generated by the user(s), such as using the process 100 of FIG. 1A. Additionally, while the example of FIG. 1B illustrates the user interface 502 providing the interface elements 504 for four categories, in other examples, the user interface 502 may include any number of interface elements associated with any number of categories.

In the example of FIG. 1B, the user(s) may select the third interface element 504(3) associated with the Entities category. As such, the user interface 502 may include interface elements 506(1)-(2) (also referred to singularly as “interface element 506” or in plural as “interface elements 506”) associated with subcategories corresponding to the Entities category. For instance, the first interface element 506(1) may allow for steering content associated with Entity 1 while the second interface element 506(2) may allow for steering content associated with Entity 2. The user interface 502 may further include an interface element 508 for suppressing content related to the selected subcategory, an interface element 510 for strengthening the content associated with the selected subcategory, and an interface element 512 associated with selecting a level between suppressing the content and strengthening the content.

For example, if the user(s) wants the model(s) 102 to suppress all content related to the selected subcategory, such as Entity 1, then the user(s) may select the interface element 508. This way, the model(s) 102 may be steered to not output content related to Entity 1 and/or output content related to other Entities, such as Entity 2. Additionally, if the user(s) wants the model(s) 102 to generate additional content related to the selected subcategory, such as again Entity 1, then the user(s) may select the interface element 510. This way, the model(s) 102 may be steered to output content related to Entity 1 and/or not output content related to other Entities, such as Entity 2. Furthermore, if the user(s) wants to set a custom level for steering the content output by the model(s) 102 for the selected subcategory, such as again Entity 1, then the user(s) may use the interface element 512.

For example, if the user(s) selects one extreme of the interface element 512, such as the left edge, then the level may be associated with suppressing the content, similar to the interface element 508. Additionally, if the user(s) selects the other extreme of the interface element 512, such as the right edge, then the level may be associated with strengthening the content, similar to the interface element 510. However, if the user(s) selects a position between the extremes, then the level may be between suppress and strengthen. For instance, if the user(s) selects the middle of the interface element 512, then the level may be associated with neutrally steering the model(s) 102 such that the model(s) 102 does not steer the content (e.g., the model(s) 102 acts as if no steering is being performed). Additionally, if the user(s) selects a left portion of the interface element 512, then the level may be more associated with suppressing the content, where the level increases towards suppression the farther to the left. Furthermore, if the user(s) selects the right portion of the interface element 512, then the level may be associated with strengthening the content, where the level increases towards strengthening the farther to the right.

In other words, the user interface 502 may allow a user to select a category, a subcategory for the category, any level of steering associated with the category, and/or any level of steering associated with the subcategory. While the example of FIG. 5 illustrates the user(s) using the user interface 502 to steer content associated with a single subcategory, in other examples, the user(s) may use the user interface 502 to steer content associated with any number of categories and/or any number of subcategories.

Referring back to the example of FIG. 1B, the process 126 may include the system(s) 116 receiving data representing at least the category 130 for steering content and the steering type 132 associated with the category 130. In some examples, the system(s) 116 may then retrieve the steering input(s) 104 associated with the category 130. Additionally, in other examples, the system(s) 116 may use the steering engine(s) 120 to update the steering input(s) 104 associated with the category 130 to generate one or more updated steering inputs 134 associated with the category 130 and/or the steering type 132.

For example, the steering input(s) 104 associated with the category 130 may correspond to a set level of steering, such as suppression, strengthening, neutral, and/or any other level. As such, if the steering type 132 indicates a steering level that differs from the set level of steering, the steering engine(s) 120 may then update the steering input(s) 104 to generate the updated steering input(s) 134 that is associated with the indicated steering level. As described herein, the steering engine(s) 120 may use any technique to update the steering input(s) 104 to generate the updated steering input(s) 134. For a first example, since the steering input(s) 104 may represent one or more values, the steering engine(s) 120 may update the steering input(s) 104 by multiplying the value(s) by a scalar value that is associated with the indicated steering level. For a second example, since the steering input(s) may again represent the value(s), the steering engine(s) 120 may update the steering input(s) 104 by adding, subtracting, and/or performing any other mathematical operation on the value(s).

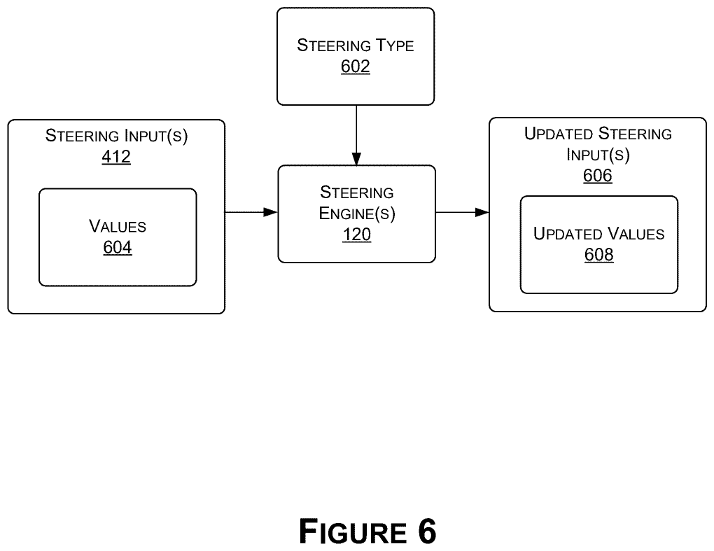

For instance, FIG. 6 illustrates an example of updating one or more steering inputs using a level of steering associated with a category to generate one or more updated steering inputs, in accordance with some embodiments of the present disclosure. As shown, the steering engine(s) 120 may receive data representing a steering type 602 associated with steering content related to a category. As described herein, the steering type 602 may indicate a level for steering the content, such as by suppressing the content, strengthening the content, and/or any degree between the suppression and the strengthening. The steering engine(s) 120 may further obtain, retrieve, and/or receive the steering input(s) 412 associated with the category. In the example of FIG. 6, the steering input(s) 412 may include a steering vector that includes values 604 associated with steering content. Additionally, the steering input(s) 412 may be associated with a set level of steering.

As such, the steering engine(s) 120 may use the steering type 602 to update the steering input(s) 412 and generate one or more updated steering inputs 606. In some examples, to update the steering input(s) 412, the steering engine(s) 120 may determine a difference between the set level of steering associated with the steering input(s) 412 and the indicated level of steering associated with the steering type 602. The steering engine(s) 120 may then use the difference perform one or more mathematical operations with respect to the values 604 of the steering input(s) 412 to generate updated values 608 associated with the updated steering input(s) 606. For example, the updated steering input(s) 606 may include an updated steering vector with the updated values 608.

Referring back to the example of FIG. 1B, the process 126 may then include the system(s) 116 receiving input data 136 from one or more other user devices 138. As described herein, the input data 136 may represent a prompt, text, an image, a video, audio, a sensor representation (e.g., a point cloud), and/or any other type of input that may be applied to and/or processed by the model(s) 102. In some examples, the user device(s) 138 may receive and/or generate the input data 136 using one or more user interfaces 140. For instance, the user interface(s) 140 may include a keyboard, a touchpad, a writing pad, a graphical interface, a mouse, a stylus, a microphone, a camera, a sensor, and/or any other type of device capable of receiving and/or generating the input data 136. In some examples, the input data 136 may be associated with requesting non-compliant content associated with the model(s) 102. However, in other examples, the input data 136 may be associated with requesting compliant content associated with the model(s) 102.

The process 126 may then include the system(s) 116 using the steering engine(s) 120 to steer content 142 associated with the input data 136. For example, if the input data 136 is associated with requesting compliant content, then the steering engine(s) 120 may allow the model(s) 102 to process the input data 136 and generate compliant content 142 related to the input data 136, such as without performing any type of steering. However, if the input data 136 is associated with requesting non-compliant content, then the steering engine(s) 120 may steer the model(s) 102 when processing the input data 136 to generate compliant content 142, such as a compliant response and/or a non-response output. As described herein, the steering engine(s) 120 may use the steering input(s) 104 and/or the updated steering input(s) 134 to steer the model(s) 102 to generate the compliant content 142.

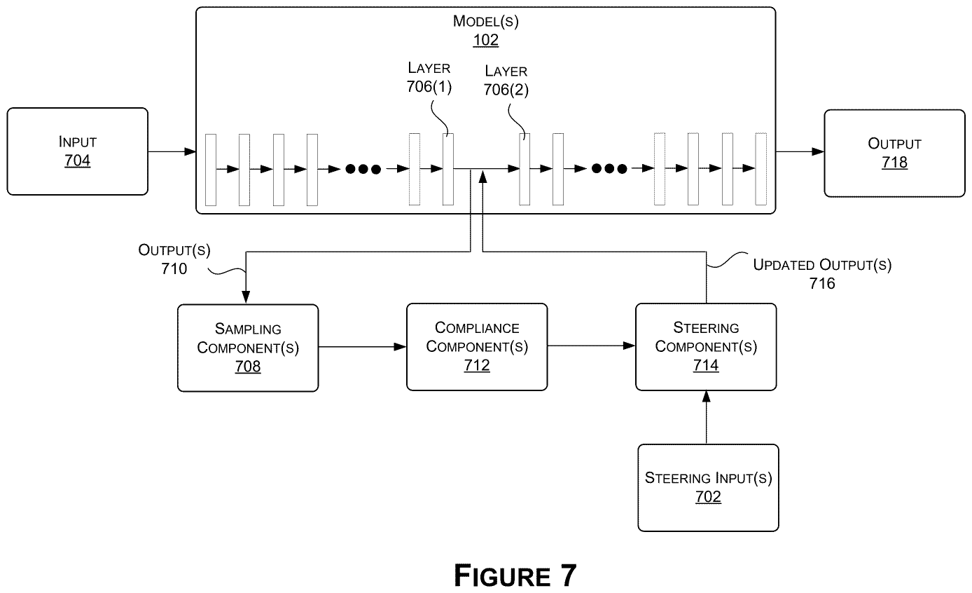

For instance, FIG. 7 illustrates an example of using one or more steering inputs 702 (which may include, and/or represent, the steering input(s) 412 and/or the updated steering input(s) 606) to steer the model(s) 102 when generating content, in accordance with some embodiments of the present disclosure. As shown, an input 704 may be applied to the model(s) 102, wherein the input 704 includes a prompt, text, an image, a video, audio, a sensor representation (e.g., a point cloud), and/or any other type of input that may be applied to and/or processed by the model(s) 102. For instance, in some examples, the input 704 may include a user prompt that is augmented with additional data, such as a system prompt, retrieval-augmented data, and/or the like. In some examples, the input 704 may include a single-turn prompt—such as a monologue prompt—with a single question/inquiry produced by the user(s). In other examples, the input 704 may include a multi-turn prompt—such as a dialogue prompt—that includes two or more user questions and at least one response.

As shown, the model(s) 102 may process the input 704 using any number of layers 706(1)-(2) (also referred to singularly as “layer 706” or in plural as “layers 706”), although only two are labeled for clarity purposes. In some examples, the model(s) 102 may include any number of layers 706 as indicated schematically with vertical rectangles. Additionally, layers 706 whose outputs are provided as inputs into other layers (rather than producing a final output) may be referred to as hidden layers. In some examples, the layers 706 may include any number of nodes, where an individual node receives any number of outputs from other nodes included in the model(s) 102. In some examples, a set of nodal outputs produced by a given layer 706 may represent an activation of the layer 706, which may include as many components (e.g., integer or floating-point values) as there are nodes in the layer 706.

As shown, one or more sampling components 708 of the steering engine(s) 120 may sample one or more outputs 710—such as one or more activations-generated by a number of hidden layers 706. For example, the sampling component(s) 708 may sample the output(s) 710 generated by the layer 706(1). Although only one of the output(s) 710 is sampled in the example of FIG. 7, in other examples, any number of outputs may be sampled by any number of layers 706. Additionally, in some examples, the output(s) 710 may include a large number of dimensions, such as may be determined by the total number of nodes associated with the layer 706(1). The sampling component(s) 708 may then provide the output(s) 710 to one or more compliance components 712 of the steering engine(s) 120, where the compliant component(s) 712 projects the output(s) 710 onto a compliance space.

For instance, in some examples, the compliance space may include a smaller number of dimensions than the number of dimensions in the output(s) 710. Additionally, in some examples, various components of the output(s) 710 may be aggregated—such as into a single component—and the output(s) 710 may be converted to a vector with a reduced number of dimensions. In some examples, the projection may include one or more non-linear operations. The compliance component(s) 712 may then determine whether the output(s) 710 corresponds to a non-compliant region in the compliance space. In some examples, the compliance component(s) 712 may use the output(s) 710 as an input to a clustering algorithm, which may determine if the output(s) 710 corresponds to a non-compliant content region.

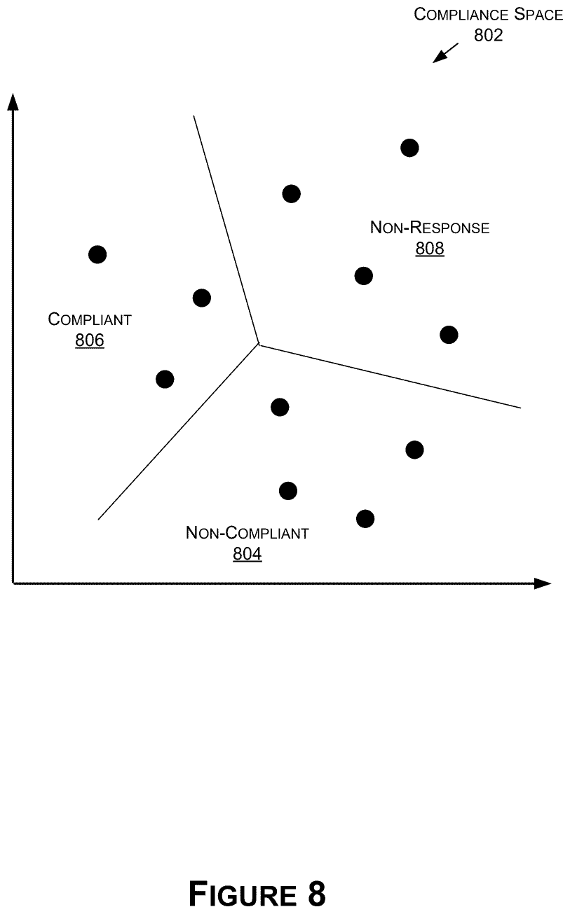

For instance, FIG. 8 illustrates an example clustering in a compliance space that may be used to steer the model(s) 102, in accordance with some embodiments of the present disclosure. As shown, a two-dimensional compliance space 802 may be used by the compliance component(s) 712 to perform steering associated with the model(s) 102 processing inputs. While the example of FIG. 8 illustrates the compliance space 802 as being two-dimensional, in other examples, a compliance space may include any other number of dimensions. Additionally, the compliance space 802 may include three different clusters of detection vectors, such as a non-compliant cluster 804, a compliant cluster 806, and a non-response cluster 808. However, in other examples, the compliance space 802 may include any other number of clusters depending on the category.

In some examples, reference vectors may be determined for the different clusters, where the reference vectors are associated with respective points in the clusters (e.g., the center points of the clusters). As such, for an input, distances may be computed between a detection vector associated with the input and the reference vectors associated with the clusters. In some examples, a distance function may compute the distances using a sum of squares of the differences between individual components of the detection vector and components of the respective centroids associated with the reference vectors. Additionally, in some examples, the distance function may weight differences between components along different axes of the compliance space 802 with different weights. The distances may then be used to associate the detection vector with a cluster, such as the cluster that corresponds to the minimum distance (and/or using any other technique).

Referring back to the example of FIG. 7, if the compliance component(s) 712 determines that the output(s) 710 is associated with a non-compliant cluster, then one or more steering components 714 may modify the output(s) 710 to steer the model(s) 102 towards a compliant content region or a non-response content region. As described herein, in some examples, modifying the output(s) 710 may use the steering input(s) 702 to generate one or more updated outputs 716. For a first example, the steering component(s) 714 may modify the output(s) 710 by combining the output(s) 710 with the steering input(s) 702. For a second example, the steering component(s) 714 may modify the output(s) by multiplying the output(s) 710 by the steering input(s) 702.

As shown, the steering component(s) 714 may then input the updated output(s) 716 into the layer 706(2) of the model(s) 102. Additionally, the model(s) 102 may then continue to process the input 704 using the updated output(s) 716 to generate an output 718 associated with the input 704. As described herein, by performing such processes, the output 718 may be compliant with the category, such as by including compliant content and/or a non-response output.

Referring back to the example of FIG. 1B, in some examples, the steering engine(s) 120 may use one or more additional and/or alternative techniques to steer the content 142 associated with the input data 136. For instance, in some examples, the steering engine(s) 120 may use one or more sparse autoencoders that are configured to activate only a portion of the layers and/or neurons of the model(s) 102 during processing in order to control the output of the content 142, such as to cause the content 142 to be compliant with regard to the category 130. In some examples, the steering input(s) 104 may indicate which of the layers and/or neurons to activate. Additionally, or alternatively, in some examples, the model(s) 102 may be trained by activating and/or deactivating the layers and/or neurons. When performing such training, the steering engine(s) 120 may use the non-compliant input(s) 112 and/or the compliant input(s) 114.

In some examples, the steering engine(s) 120 may use one or more circuit breakers, which may also be represented by the steering input(s) 104, to steer the content 142 associated with the input data 136. For example, the circuit breaker(s) may be used to control the behavior of the model(s) 102, such as by preventing the model(s) 102 from processing input data 136 that is associated with a non-compliant input associated with the category 130 and/or causing the model(s) 102 to refrain from generating non-compliant content 142 associated with the category 130. In some examples, the circuit breaker(s) may be learned during training of the model(s) 102. For instance, in some examples, the circuit breaker(s) may be learned using the non-compliant input(s) 112 and/or the compliant input(s) 114 associated with the category 130. Still, in some examples, the circuit breaker(s) may be learned using any other technique.

In some examples, the steering engine(s) 120 may use one or more learning techniques to steer the content 142 associated with the input data 136. For example, such as before receiving the input data 136 and/or based on receiving the category 130 and/or the steering type 132, the steering engine(s) 120 may retrain the model(s) 102 to remove one or more data points associated with the model(s) 102 that may cause the model(s) 102 to generate non-compliant content 142 associated with the category 130. In such examples, the steering engine(s) 120 may perform the retraining using the non-compliant input(s) 112 and/or the compliant input(s) 114 associated with the category 130. While these are just a few additional example techniques for how the steering engine(s) 120 may steer the content 142 generated by the model(s) 102, in other examples, the steering engine(s) 120 may use additional and/or alternative techniques.

The process 126 may include the system(s) 116 sending the compliant content 142 back to the user device(s) 138. Additionally, in some examples, the process 126 may continue to repeat such that the system(s) 116 receives input data 136 representing one or more inputs from the user device(s) 138, processes the input(s) using the model(s) 102 to generate compliant content 142 associated with the category 130, and then sends the compliant content 142 back to the user device(s) 138. While the example of FIG. 1B describes the system(s) 116 as steering content associated with a single category 130 configured using the user device(s) 108, in other examples, similar processes may be used to steer content for any number of categories 106 configured by the user device(s) 108.

As described herein, in some examples, the user device(s) 108, the user device(s) 138, and/or the system(s) 116 may include one or more of the components illustrated in the example of FIG. 13 and/or the example of FIG. 14. For example, the user device(s) 108, the user device(s) 138, and/or the system(s) 116 may include and/or be similar to an example computing device 1300 and/or an example data center 1400.

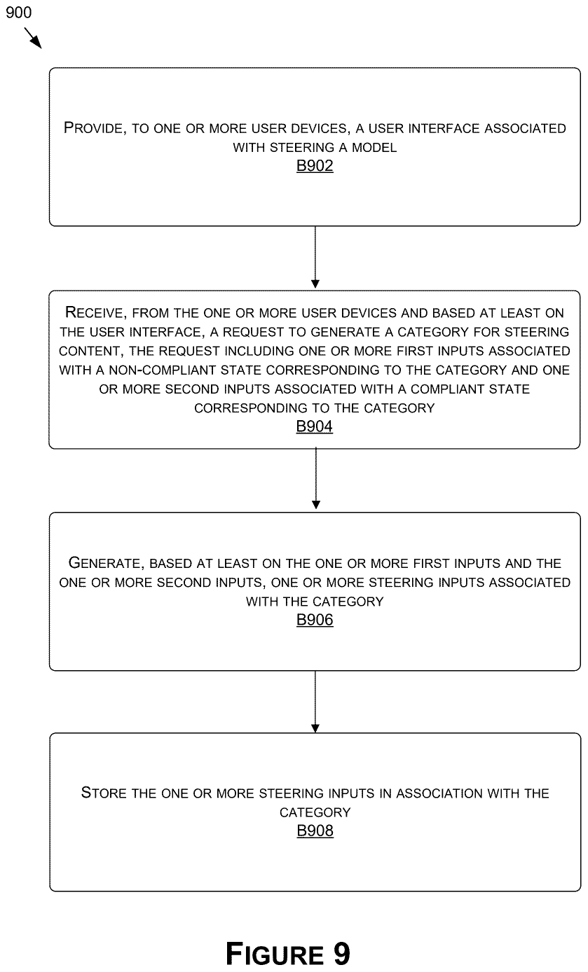

Now referring to FIGS. 9-11 each block of methods 900, 1000, and 1100 described herein, comprises a computing process that may be performed using any combination of hardware, firmware, and/or software. For instance, various functions may be carried out by a processor executing instructions stored in memory. The methods 900, 1000, and 1100 may also be embodied as computer-usable instructions stored on computer storage media. The methods 900, 1000, and 1100 may be provided by a standalone application, a service or hosted service (standalone or in combination with another hosted service), or a plug-in to another product, to name a few. In addition, these methods 900, 1000, and 1100 described, by way of example, with respect to FIGS. 1A-1B. However, these methods 900, 1000, and 1100 may additionally or alternatively be executed by any one system, or any combination of systems, including, but not limited to, those described herein.

FIG. 9 illustrates a flow diagram showing a method 900 for using a model to generate one or more customized steering inputs association with a category, in accordance with some embodiments of the present disclosure. The method 900, at block B902, may include providing, to one or more user devices, a user interface associated with steering a model. For instance, the system(s) 116 may provide the user interface(s) 110 to the user device(s) 108, where the user interface(s) 110 is associated with steering the model(s) 102. For example, the user interface(s) 110 may allow for the user(s) to generate new steering inputs 104 associated with existing and/or new categories 106 for steering the model(s) 102.

The method 900, at block B904, may include receiving, from the one or more user devices and based at least on the user interface, a request to generate a category for steering content, the request including one or more first inputs associated with a non-compliant state corresponding to a category and one or more second inputs associated with a compliant state corresponding to the category. For instance, the system(s) 116 may receive, from the user device(s) 108, a request to generate the steering input(s) 104 associated with the category 106. As described herein, in some examples, the request may include the non-compliant input(s) 112 and the compliant input(s) 114 associated with the category 106. Additionally, the user device(s) 108 may receive the request, the non-compliant input(s) 112, and/or the compliant input(s) 114 using the user interface(s) 110.

The method 900, at block B906, may include generating, based at least on the one or more first inputs and the one or more second inputs, one or more steering inputs associated with the category. For instance, the system(s) (e.g., the steering engine(s) 120) may generate the steering input(s) 104 using at least the non-compliant input(s) 112 and the compliant input(s) 114. As described herein, in some examples, to generate the steering input(s), the system(s) 116 may obtain one or more first outputs based at least on the model(s) 102 processing the non-compliant input(s) 112 and one or more second outputs based at least on the model(s) 102 processing the compliant input(s) 114. The system(s) 116 may then generate, using one or more techniques, the steering input(s) 104 using the first output(s) and the second output(s).

The method 900, at block B908 may include storing, in one or more databases, the one or more steering vectors in association with the category. For instance, the system(s) 116 may at least store data representing the steering input(s) 104 in association with data representing the category 106. Additionally, in some examples, the system(s) 116 may store the data representing the steering input(s) 104 and/or the data representing the category 106 in association with the user profile(s) 124 associated with the user(s).

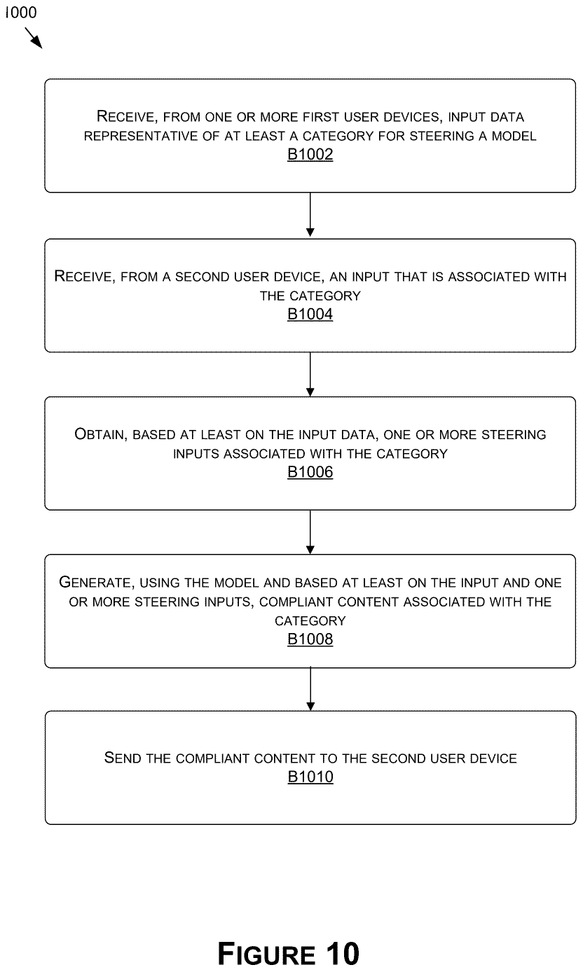

FIG. 10 illustrates a flow diagram showing a method 1000 for using parameters set by a user to steer content generated by one or more models, in accordance with some embodiments of the present disclosure. The method 1000, at block B1002, may include receiving, from one or more first user devices, input data representative of at least a category for steering a model. For instance, the system(s) may receive, from the first user device(s) 108, the input data representing at least the category 130 for steering the model(s) 102. In some examples, the input data may further represent the steering type 132 associated with steering the model(s) 102. Additionally, the steering type 132 may include suppressing the output of content associated with the category 106, strengthening the output of content associated with the category 130, and/or a level between the suppression and the strengthening.

The method 1000, at block B1004, may include receiving, from a second user device, an input associated with the category. For instance, the system(s) 116 may receive the input data 136 representing the input from the second user device(s) 138. As described herein, the input may include a prompt, text, an image, a video, audio, a sensor representation (e.g., a point cloud), and/or any other type of input that may be applied to and/or processed by the model(s) 102.

The method 1000, at block B1006, may include obtaining, based at least on the input data, one or more steering inputs associated with the category. For instance, the system(s) 116 (e.g., the steering engine(s) 120) may obtain the steering input(s) 104 associated with the category 130. In some examples, the system(s) 116 obtains the steering input(s) 104 based at least on receiving the input data 136. Additionally, in some examples, the system(s) 116 may update the steering input(s) 104 to generate one or more updated steering inputs 134, such as based on the steering type 132.

The method 1000, at block B1008, may include generating, using the model and based at least on the input and one or more steering inputs, compliant content associated with the input. For instance, the system(s) 116 may apply the input to the model(s) 102. During processing of the input, the system(s) 116 (e.g., the steering engine(s) 120) may then steer the processing performed by the model(s) 102 using the steering input(s) 104 (and/or the updated steering input(s) 134). For example, the system(s) 116 may use one or more intermediate output—such as one or more activations—to determine that a non-compliant output may be generated. As such, the system(s) 116 may update the intermediate output(s) using the steering input(s) 104 and then apply the updated output(s) to the model(s) 102 for further processing. This way, the model(s) 102 generates the compliant content 142 associated with the input.

The method 1000, at block B1008, may include sending the compliant content to the second user device. For instance, the system(s) 116 may send the compliant content 142 to the second user device(s) 138.

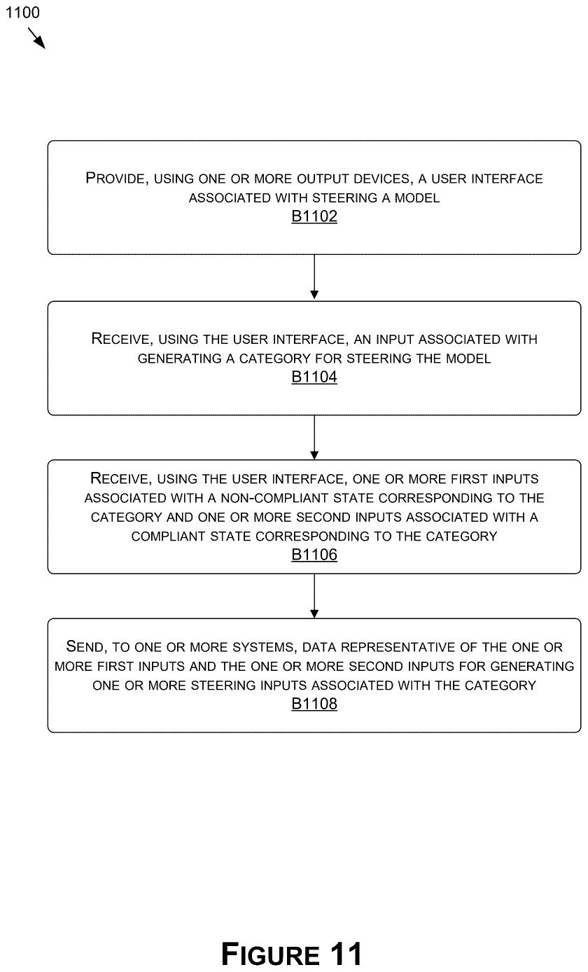

FIG. 11 illustrates a flow diagram showing a method 1100 for using a user interface to steer content generated by one or more models during deployment, in accordance with some embodiments of the present disclosure. The method 1100, at block B1102, may include providing, using one or more output devices, a user interface associated with steering a model. For instance, the user device(s) 108 may provide the user interface(s) 110 that is associated with steering content generated using the model(s) 102. As described herein, in some examples, the user interface(s) 110 may include one or more interface elements associated with steering one or more general categories 106 and/or one or more interface elements associated with steering one or more customized categories 106.

The method 1100, at block B1104, may include receiving, using the user interface, an input associated with a category for steering the model and the method 1100, at block B1106, may include receiving, using the user interface, one or more first inputs associated with a non-compliant state corresponding to the category and one or more second inputs associated with a compliant state corresponding to the category. For instance, the user device(s) 108 may receive, using the user interface(s) 110, the indication of the category 106 (and/or the subcategory) for steering the model(s) 102. The user device(s) 108 may then receive, using the user interface(s) 110, the non-compliant input(s) 112 associated with the category 106 and the compliant input(s) 114 associated with the category 106.

The method 1100, at block B1108, may include sending, to one or more systems, data representative of the one or more first inputs and the one or more second inputs for generating one or more steering inputs associated with the category. For instance, the user device(s) 108 may send at least the non-compliant input(s) 112 and the compliant input(s) 114 to the system(s) 116. Additionally, the system(s) 116 may then use one or more of the techniques described herein to generate the steering input(s) 104 using the non-compliant input(s) 112 and the compliant input(s) 114.

### EXAMPLE LANGUAGE MODELS

In at least some embodiments, language models, such as large language models (LLMs), vision language models (VLMs), multi-modal language models (MMLMs), and/or other types of generative artificial intelligence (AI) may be implemented. These models may be capable of understanding, summarizing, translating, and/or otherwise generating text (e.g., natural language text, code, etc.), images, video, computer aided design (CAD) assets, OMNIVERSE and/or METAVERSE file information (e.g., in USD format, such as OpenUSD), and/or the like, based on the context provided in input prompts or queries. These language models may be considered “large,” in embodiments, based on the models being trained on massive datasets and having architectures with large number of learnable network parameters (weights and biases) such as millions or billions of parameters. The LLMs/VLMs/MMLMs/etc. may be implemented for summarizing textual data, analyzing and extracting insights from data (e.g., textual, image, video, etc.), and generating new text/image/video/etc. in user-specified styles, tones, and/or formats. The LLMs/VLMs/MMLMs/etc. of the present disclosure may be used exclusively for text processing, in embodiments, whereas in other embodiments, multi-modal LLMs may be implemented to accept, understand, and/or generate text and/or other types of content like images, audio, 2D and/or 3D data (e.g., in USD formats), and/or video. For example, vision language models (VLMs), or more generally multi-modal language models (MMLMs), may be implemented to accept image, video, audio, textual, 3D design (e.g., CAD), and/or other inputs data types and/or to generate or output image, video, audio, textual, 3D design, and/or other output data types.

Various types of LLMs/VLMs/MMLMs/etc. architectures may be implemented in various embodiments. For example, different architectures may be implemented that use different techniques for understanding and generating outputs—such as text, audio, video, image, 2D and/or 3D design or asset data, etc. In some embodiments, LLMs/VLMs/MMLMs/etc. architectures such as recurrent neural networks (RNNs) or long short-term memory networks (LSTMs) may be used, while in other embodiments transformer architectures—such as those that rely on self-attention and/or cross-attention (e.g., between contextual data and textual data) mechanisms—may be used to understand and recognize relationships between words or tokens and/or contextual data (e.g., other text, video, image, design data, USD, etc.). One or more generative processing pipelines that include LLMs/VLMs/MMLMs/etc. may also include one or more diffusion block(s) (e.g., denoisers). The LLMs/VLMs/MMLMs/etc. of the present disclosure may include encoder and/or decoder block(s). For example, discriminative or encoder-only models like BERT (Bidirectional Encoder Representations from Transformers) may be implemented for tasks that involve language comprehension such as classification, sentiment analysis, question answering, and named entity recognition. As another example, generative or decoder-only models like GPT (Generative Pretrained Transformer) may be implemented for tasks that involve language and content generation such as text completion, story generation, and dialogue generation. LLMs/VLMs/MMLMs/etc. that include both encoder and decoder components like T5 (Text-to-Text Transformer) may be implemented to understand and generate content, such as for translation and summarization. These examples are not intended to be limiting, and any architecture type including but not limited to those described herein—may be implemented depending on the particular embodiment and the task(s) being performed using the LLMs/VLMs/MMLMs/etc.

In various embodiments, the LLMs/VLMs/MMLMs/etc. may be trained using unsupervised learning, in which an LLMs/VLMs/MMLMs/etc. learns patterns from large amounts of unlabeled text/audio/video/image/design/USD/etc. data. Due to the extensive training, in embodiments, the models may not require task-specific or domain-specific training. LLMs/VLMs/MMLMs/etc. that have undergone extensive pre-training on vast amounts of unlabeled data may be referred to as foundation models and may be adept at a variety of tasks like question-answering, summarization, filling in missing information, translation, image/video/design/USD/data generation. Some LLMs/VLMs/MMLMs/etc. may be tailored for a specific use case using techniques like prompt tuning, fine-tuning, retrieval augmented generation (RAG), adding adapters (e.g., customized neural networks, and/or neural network layers, that tune or adjust prompts or tokens to bias the language model toward a particular task or domain), and/or using other fine-tuning or tailoring techniques that optimize the models for use on particular tasks and/or within particular domains.

In some embodiments, the LLMs/VLMs/MMLMs/etc. of the present disclosure may be implemented using various model alignment techniques. For example, in some embodiments, guardrails may be implemented to identify improper or undesired inputs (e.g., prompts) and/or outputs of the models. In doing so, the system may use the guardrails and/or other model alignment techniques to either prevent a particular undesired input from being processed using the LLMs/VLMs/MMLMs/etc., and/or preventing the output or presentation (e.g., display, audio output, etc.) of information generating using the LLMs/VLMs/MMLMs/etc. In some embodiments, one or more additional models- or layers thereof—may be implemented to identify issues with inputs and/or outputs of the models. For example, these “safeguard” models may be trained to identify inputs and/or outputs that are “safe” or otherwise okay or desired and/or that are “unsafe” or are otherwise undesired for the particular application/implementation. As a result, the LLMs/VLMs/MMLMs of the present disclosure may be less likely to output language/text/audio/video/design data/USD data/etc. that may be offensive, vulgar, improper, unsafe, out of domain, and/or otherwise undesired for the particular application/implementation.

In some embodiments, the LLMs/VLMs/etc. may be configured to or capable of accessing or using one or more plug-ins, application programming interfaces (APIs), databases, data stores, repositories, etc. For example, for certain tasks or operations that the model is not ideally suited for, the model may have instructions (e.g., as a result of training, and/or based on instructions in a given prompt) to access one or more plug-ins (e.g., 3^{rd} party plugins) for help in processing the current input. In such an example, where at least part of a prompt is related to restaurants or weather, the model may access one or more restaurant or weather plug-ins (e.g., via one or more APIs) to retrieve the relevant information. As another example, where at least part of a response requires a mathematical computation, the model may access one or more math plug-ins or APIs for help in solving the problem(s), and may then use the response from the plug-in and/or API in the output from the model. This process may be repeated—e.g., recursively—for any number of iterations and using any number of plug-ins and/or APIs until a response to the input prompt can be generated that addresses each ask/question/request/process/operation/etc. As such, the model(s) may not only rely on its own knowledge from training on a large dataset(s), but also on the expertise or optimized nature of one or more external resources—such as APIs, plug-ins, and/or the like.

In some embodiments, multiple language models (e.g., LLMs/VLMs/MMLMs/etc., multiple instances of the same language model, and/or multiple prompts provided to the same language model or instance of the same language model may be implemented, executed, or accessed (e.g., using one or more plug-ins, user interfaces, APIs, databases, data stores, repositories, etc.) to provide output responsive to the same query, or responsive to separate portions of a query. In at least one embodiment, multiple language models e.g., language models with different architectures, language models trained on different (e.g. updated) corpuses of data may be provided with the same input query and prompt (e.g., set of constraints, conditioners, etc.). In one or more embodiments, the language models may be different versions of the same foundation model. In one or more embodiments, at least one language model may be instantiated as multiple agents—e.g., more than one prompt may be provided to constrain, direct, or otherwise influence a style, a content, or a character, etc., of the output provided. In one or more example, non-limiting embodiments, the same language model may be asked to provide output corresponding to a different role, perspective, character, or having a different base of knowledge, etc.-as defined by a supplied prompt.

In any one of such embodiments, the output of two or more (e.g., each) language models, two or more versions of at least one language model, two or more instanced agents of at least one language model, and/or two more prompts provided to at least one language model may be further processed, e.g., aggregated, compared or filtered against, or used to determine (and provide) a consensus response. In one or more embodiments, the output from one language model -or version, instance, or agent-maybe be provided as input to another language model for further processing and/or validation. In one or more embodiments, a language model may be asked to generate or otherwise obtain an output with respect to an input source material, with the output being associated with the input source material. Such an association may include, for example, the generation of a caption or portion of text that is embedded (e.g., as metadata) with an input source text or image. In one or more embodiments, an output of a language model may be used to determine the validity of an input source material for further processing, or inclusion in a dataset. For example, a language model may be used to assess the presence (or absence) of a target word in a portion of text or an object in an image, with the text or image being annotated to note such presence (or lack thereof). Alternatively, the determination from the language model may be used to determine whether the source material should be included in a curated dataset, for example and without limitation.

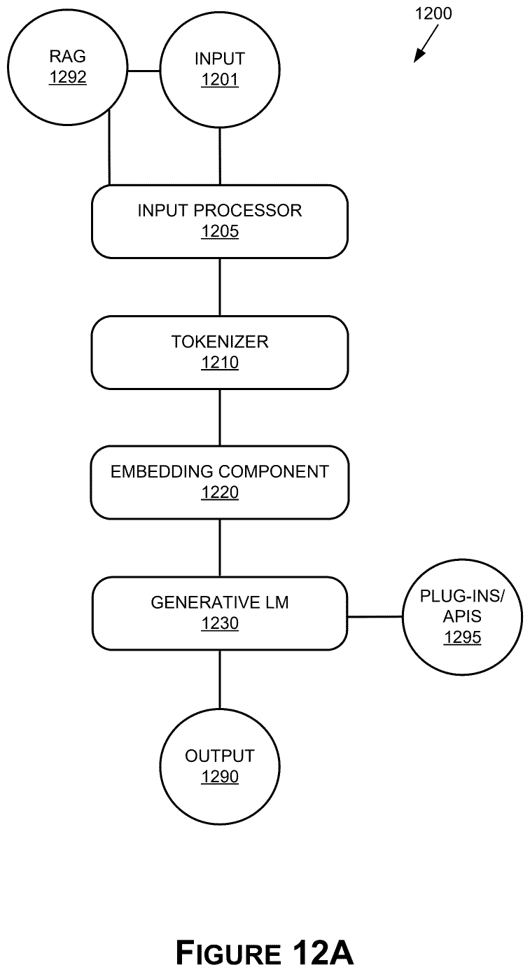

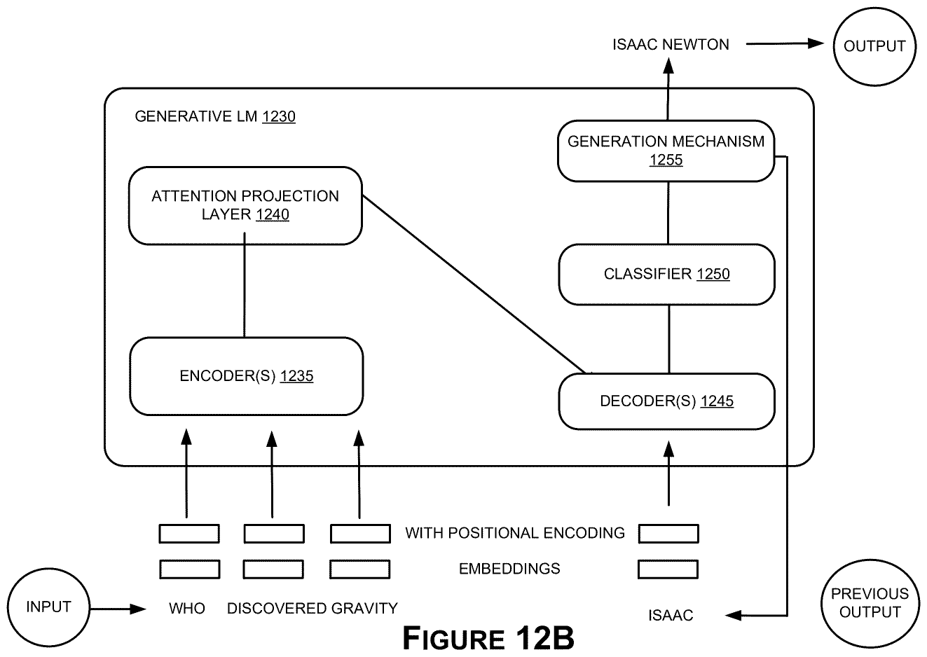

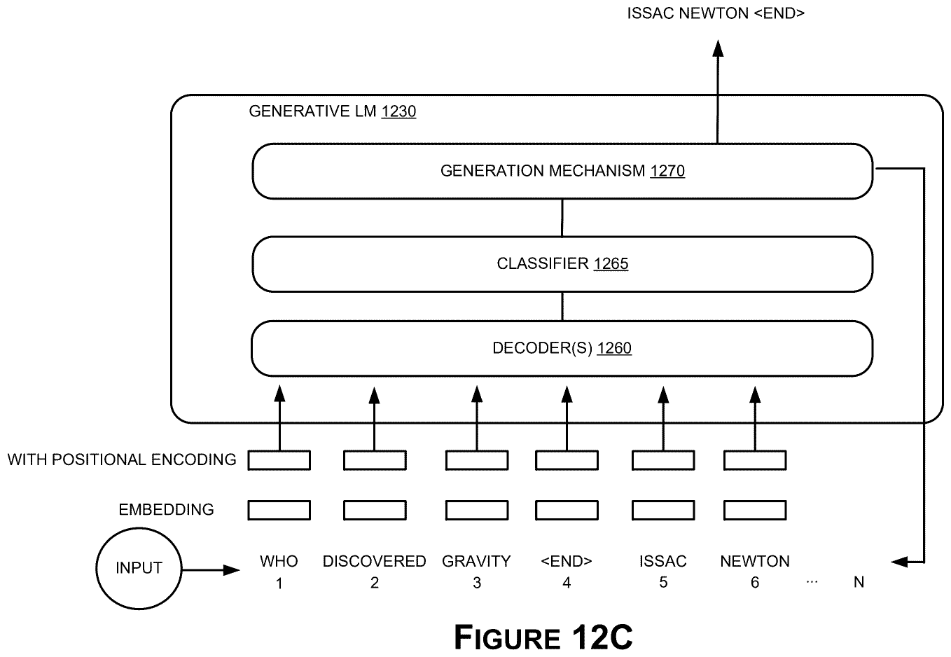

FIG. 12A is a block diagram of an example generative language model system 1200 suitable for use in implementing at least some embodiments of the present disclosure. In the example illustrated in FIG. 12A, the generative language model system 1200 includes a retrieval augmented generation (RAG) component 1292, an input processor 1205, a tokenizer 1210, an embedding component 1220, plug-ins/APIs 1295, and a generative language model (LM) 1230 (which may include an LLM, a VLM, a multi-modal LM, etc.).

At a high level, the input processor 1205 may receive an input 1201 comprising text and/or other types of input data (e.g., audio data, video data, image data, sensor data (e.g., LiDAR, RADAR, ultrasonic, etc.), 3D design data, CAD data, universal scene descriptor (USD) data—such as OpenUSD, etc.), depending on the architecture of the generative LM 1230 (e.g., LLM/VLM/MMLM/etc.). In some embodiments, the input 1201 includes plain text in the form of one or more sentences, paragraphs, and/or documents. Additionally or alternatively, the input 1201 may include numerical sequences, precomputed embeddings (e.g., word or sentence embeddings), and/or structured data (e.g., in tabular formats, JSON, or XML). In some implementations in which the generative LM 1230 is capable of processing multi-modal inputs, the input 1201 may combine text (or may omit text) with image data, audio data, video data, design data, USD data, and/or other types of input data, such as but not limited to those described herein. Taking raw input text as an example, the input processor 1205 may prepare raw input text in various ways. For example, the input processor 1205 may perform various types of text filtering to remove noise (e.g., special characters, punctuation, HTML tags, stopwords, portions of an image(s), portions of audio, etc.) from relevant textual content. In an example involving stopwords (common words that tend to carry little semantic meaning), the input processor 1205 may remove stopwords to reduce noise and focus the generative LM 1230 on more meaningful content. The input processor 1205 may apply text normalization, for example, by converting all characters to lowercase, removing accents, and/or or handling special cases like contractions or abbreviations to ensure consistency. These are just a few examples, and other types of input processing may be applied.

In some embodiments, a RAG component 1292 (which may include one or more RAG models, and/or may be performed using the generative LM 1230 itself) may be used to retrieve additional information to be used as part of the input 1201 or prompt. RAG may be used to enhance the input to the LLM/VLM/MMLM/etc. with external knowledge, so that answers to specific questions or queries or requests are more relevant—such as in a case where specific knowledge is required. The RAG component 1292 may fetch this additional information (e.g., grounding information, such as grounding text/image/video/audio/USD/CAD/etc.) from one or more external sources, which can then be fed to the LLM/VLM/MMLM/etc. along with the prompt to improve accuracy of the responses or outputs of the model.

For example, in some embodiments, the input 1201 may be generated using the query or input to the model (e.g., a question, a request, etc.) in addition to data retrieved using the RAG component 1292. In some embodiments, the input processor 1205 may analyze the input 1201 and communicate with the RAG component 1292 (or the RAG component 1292 may be part of the input processor 1205, in embodiments) in order to identify relevant text and/or other data to provide to the generative LM 1230 as additional context or sources of information from which to identify the response, answer, or output 1290, generally. For example, where the input indicates that the user is interested in a desired tire pressure for a particular make and model of vehicle, the RAG component 1292 may retrieve—using a RAG model performing a vector search in an embedding space, for example—the tire pressure information or the text corresponding thereto from a digital (embedded) version of the user manual for that particular vehicle make and model. Similarly, where a user revisits a chatbot related to a particular product offering or service, the RAG component 1292 may retrieve a prior stored conversation history—or at least a summary thereof—and include the prior conversation history along with the current ask/request as part of the input 1201 to the generative LM 1230.

The RAG component 1292 may use various RAG techniques. For example, naïve RAG may be used where documents are indexed, chunked, and applied to an embedding model to generate embeddings corresponding to the chunks. A user query may also be applied to the embedding model and/or another embedding model of the RAG component 1292 and the embeddings of the chunks along with the embeddings of the query may be compared to identify the most similar/related embeddings to the query, which may be supplied to the generative LM 1230 to generate an output.

In some embodiments, more advanced RAG techniques may be used. For example, prior to passing chunks to the embedding model, the chunks may undergo pre-retrieval processes (e.g., routing, rewriting, metadata analysis, expansion, etc.). In addition, prior to generating the final embeddings, post-retrieval processes (e.g., re-ranking, prompt compression, etc.) may be performed on the outputs of the embedding model prior to final embeddings being used as comparison to an input query.

As a further example, modular RAG techniques may be used, such as those that are similar to naïve and/or advanced RAG, but also include features such as hybrid search, recursive retrieval and query engines, StepBack approaches, sub-queries, and hypothetical document embedding.

As another example, Graph RAG may use knowledge graphs as a source of context or factual information. Graph RAG may be implemented using a graph database as a source of contextual information sent to the LLM/VLM/MMLM/etc. Rather than (or in addition to) providing the model with chunks of data extracted from larger sized documents—which may result in a lack of context, factual correctness, language accuracy, etc.—graph RAG may also provide structured entity information to the LLM/VLM/MMLM/etc. by combining the structured entity textual description with its many properties and relationships, allowing for deeper insights by the model. When implementing graph RAG, the systems and methods described herein use a graph as a content store and extract relevant chunks of documents and ask the LLM/VLM/MMLM/etc. to answer using them. The knowledge graph, in such embodiments, may contain relevant textual content and metadata about the knowledge graph as well as be integrated with a vector database. In some embodiments, the graph RAG may use a graph as a subject matter expert, where descriptions of concepts and entities relevant to a query/prompt may be extracted and passed to the model as semantic context. These descriptions may include relationships between the concepts. In other examples, the graph may be used as a database, where part of a query/prompt may be mapped to a graph query, the graph query may be executed, and the LLM/VLM/MMLM/etc. may summarize the results. In such an example, the graph may store relevant factual information, and a query (natural language query) to graph query tool (NL-to-Graph-query tool) and entity linking may be used. In some embodiments, graph RAG (e.g., using a graph database) may be combined with standard (e.g., vector database) RAG, and/or other RAG types, to benefit from multiple approaches.

In any embodiments, the RAG component 1292 may implement a plugin, API, user interface, and/or other functionality to perform RAG. For example, a graph RAG plug-in may be used by the LLM/VLM/MMLM/etc. to run queries against the knowledge graph to extract relevant information for feeding to the model, and a standard or vector RAG plug-in may be used to run queries against a vector database. For example, the graph database may interact with a plug-in's REST interface such that the graph database is decoupled from the vector database and/or the embeddings models.

The tokenizer 1210 may segment the (e.g., processed) text data into smaller units (tokens) for subsequent analysis and processing. The tokens may represent individual words, subwords, characters, portions of audio/video/image/etc., depending on the implementation. Word-based tokenization divides the text into individual words, treating each word as a separate token. Subword tokenization breaks down words into smaller meaningful units (e.g., prefixes, suffixes, stems), enabling the generative LM 1230 to understand morphological variations and handle out-of-vocabulary words more effectively. Character-based tokenization represents each character as a separate token, enabling the generative LM 1230 to process text at a fine-grained level. The choice of tokenization strategy may depend on factors such as the language being processed, the task at hand, and/or characteristics of the training dataset. As such, the tokenizer 1210 may convert the (e.g., processed) text into a structured format according to tokenization schema being implemented in the particular embodiment.

The embedding component 1220 may use any known embedding technique to transform discrete tokens into (e.g., dense, continuous vector) representations of semantic meaning. For example, the embedding component 1220 may use pre-trained word embeddings (e.g., Word2Vec, GloVe, or FastText), one-hot encoding, Term Frequency-Inverse Document Frequency (TF-IDF) encoding, one or more embedding layers of a neural network, and/or otherwise.

In some implementations in which the input 1201 includes image data/video data/etc., the input processor 1201 may resize the data to a standard size compatible with format of a corresponding input channel and/or may normalize pixel values to a common range (e.g., 0 to 1) to ensure a consistent representation, and the embedding component 1220 may encode the image data using any known technique (e.g., using one or more convolutional neural networks (CNNs) to extract visual features). In some implementations in which the input 1201 includes audio data, the input processor 1201 may resample an audio file to a consistent sampling rate for uniform processing, and the embedding component 1220 may use any known technique to extract and encode audio features—such as in the form of a spectrogram (e.g., a mel-spectrogram). In some implementations in which the input 1201 includes video data, the input processor 1201 may extract frames or apply resizing to extracted frames, and the embedding component 1220 may extract features such as optical flow embeddings or video embeddings and/or may encode temporal information or sequences of frames. In some implementations in which the input 1201 includes multi-modal data, the embedding component 1220 may fuse representations of the different types of data (e.g., text, image, audio, USD, video, design, etc.) using techniques like early fusion (concatenation), late fusion (sequential processing), attention-based fusion (e.g., self-attention, cross-attention), etc.

The generative LM 1230 and/or other components of the generative LM system 1200 may use different types of neural network architectures depending on the implementation. For example, transformer-based architectures such as those used in models like GPT may be implemented, and may include self-attention mechanisms that weigh the importance of different words or tokens in the input sequence and/or feedforward networks that process the output of the self-attention layers, applying non-linear transformations to the input representations and extracting higher-level features. Some non-limiting example architectures include transformers (e.g., encoder-decoder, decoder only, multi-modal), RNNs, LSTMs, fusion models, diffusion models, cross-modal embedding models that learn joint embedding spaces, graph neural networks (GNNs), hybrid architectures combining different types of architectures adversarial networks like generative adversarial networks or GANs or adversarial autoencoders (AAEs) for joint distribution learning, and others. As such, depending on the implementation and architecture, the embedding component 1220 may apply an encoded representation of the input 1201 to the generative LM 1230, and the generative LM 1230 may process the encoded representation of the input 1201 to generate an output 1290, which may include responsive text and/or other types of data.

As described herein, in some embodiments, the generative LM 1230 may be configured to access or use- or capable of accessing or using-plug-ins/APIs 1295 (which may include one or more plug-ins, application programming interfaces (APIs), databases, data stores, repositories, etc.). For example, for certain tasks or operations that the generative LM 1230 is not ideally suited for, the model may have instructions (e.g., as a result of training, and/or based on instructions in a given prompt, such as those retrieved using the RAG component 1292) to access one or more plug-ins/APIs 1295 (e.g., 3^{rd} party plugins) for help in processing the current input. In such an example, where at least part of a prompt is related to restaurants or weather, the model may access one or more restaurant or weather plug-ins (e.g., via one or more APIs), send at least a portion of the prompt related to the particular plug-in/API 1295 to the plug-in/API 1295, the plug-in/API 1295 may process the information and return an answer to the generative LM 1230, and the generative LM 1230 may use the response to generate the output 1290. This process may be repeated—e.g., recursively—for any number of iterations and using any number of plug-ins/APIs 1295 until an output 1290 that addresses each ask/question/request/process/operation/etc. from the input 1201 can be generated. As such, the model(s) may not only rely on its own knowledge from training on a large dataset(s) and/or from data retrieved using the RAG component 1292, but also on the expertise or optimized nature of one or more external resources—such as the plug-ins/APIs 1295.

FIG. 12B is a block diagram of an example implementation in which the generative LM 1230 includes a transformer encoder-decoder. For example, assume input text such as “Who discovered gravity” is tokenized (e.g., by the tokenizer1210 of FIG. 12A) into tokens such as words, and each token is encoded (e.g., by the embedding component 1220 of FIG. 912A) into a corresponding embedding (e.g., of size 512). Since these token embeddings typically do not represent the position of the token in the input sequence, any known technique may be used to add a positional encoding to each token embedding to encode the sequential relationships and context of the tokens in the input sequence. As such, the (e.g., resulting) embeddings may be applied to one or more encoder(s) 1235 of the generative LM 1230.

In an example implementation, the encoder(s) 1235 forms an encoder stack, where each encoder includes a self-attention layer and a feedforward network. In an example transformer architecture, each token (e.g., word) flows through a separate path. As such, each encoder may accept a sequence of vectors, passing each vector through the self-attention layer, then the feedforward network, and then upwards to the next encoder in the stack. Any known self-attention technique may be used. For example, to calculate a self-attention score for each token (word), a query vector, a key vector, and a value vector may be created for each token, a self-attention score may be calculated for pairs of tokens by taking the dot product of the query vector with the corresponding key vectors, normalizing the resulting scores, multiplying by corresponding value vectors, and summing weighted value vectors. The encoder may apply multi-headed attention in which the attention mechanism is applied multiple times in parallel with different learned weight matrices. Any number of encoders may be cascaded to generate a context vector encoding the input. An attention projection layer 1240 may convert the context vector into attention vectors (keys and values) for the decoder(s) 1245.

In an example implementation, the decoder(s) 1245 form a decoder stack, where each decoder includes a self-attention layer, an encoder-decoder self-attention layer that uses the attention vectors (keys and values) from the encoder to focus on relevant parts of the input sequence, and a feedforward network. As with the encoder(s) 1235, in an example transformer architecture, each token (e.g., word) flows through a separate path in the decoder(s) 1245. During a first pass, the decoder(s) 1245, a classifier 1250, and a generation mechanism 1255 may generate a first token, and the generation mechanism 1255 may apply the generated token as an input during a second pass. The process may repeat in a loop, successively generating and adding tokens (e.g., words) to the output from the preceding pass and applying the token embeddings of the composite sequence with positional encodings as an input to the decoder(s) 1245 during a subsequent pass, sequentially generating one token at a time (known as auto-regression) until predicting a symbol or token that represents the end of the response. Within each decoder, the self-attention layer is typically constrained to attend only to preceding positions in the output sequence by applying a masking technique (e.g., setting future positions to negative infinity) before the softmax operation. In an example implementation, the encoder-decoder attention layer operates similarly to the (e.g., multi-headed) self-attention in the encoder(s) 1235, except that it creates its queries from the layer below it and takes the keys and values (e.g., matrix) from the output of the encoder(s) 1235.

As such, the decoder(s) 1245 may output some decoded (e.g., vector) representation of the input being applied during a particular pass. The classifier 1250 may include a multi-class classifier comprising one or more neural network layers that project the decoded (e.g., vector) representation into a corresponding dimensionality (e.g., one dimension for each supported word or token in the output vocabulary) and a softmax operation that converts logits to probabilities. As such, the generation mechanism 1255 may select or sample a word or token based on a corresponding predicted probability (e.g., select the word with the highest predicted probability) and append it to the output from a previous pass, generating each word or token sequentially. The generation mechanism 1255 may repeat the process, triggering successive decoder inputs and corresponding predictions until selecting or sampling a symbol or token that represents the end of the response, at which point, the generation mechanism 1255 may output the generated response.

FIG. 12C is a block diagram of an example implementation in which the generative LM 1230 includes a decoder-only transformer architecture. For example, the decoder(s) 1260 of FIG. 12C may operate similarly as the decoder(s) 1245 of FIG. 12B except each of the decoder(s) 1260 of FIG. 12C omits the encoder-decoder self-attention layer (since there is no encoder in this implementation). As such, the decoder(s) 1260 may form a decoder stack, where each decoder includes a self-attention layer and a feedforward network. Furthermore, instead of encoding the input sequence, a symbol or token representing the end of the input sequence (or the beginning of the output sequence) may be appended to the input sequence, and the resulting sequence (e.g., corresponding embeddings with positional encodings) may be applied to the decoder(s) 1260. As with the decoder(s) 1245 of FIG. 12B, each token (e.g., word) may flow through a separate path in the decoder(s) 1260, and the decoder(s) 1260, a classifier 1265, and a generation mechanism 1270 may use auto-regression to sequentially generate one token at a time until predicting a symbol or token that represents the end of the response. The classifier 1265 and the generation mechanism 1270 may operate similarly as the classifier 1250 and the generation mechanism 1255 of FIG. 12B, with the generation mechanism 1270 selecting or sampling each successive output token based on a corresponding predicted probability and appending it to the output from a previous pass, generating each token sequentially until selecting or sampling a symbol or token that represents the end of the response. These and other architectures described herein are meant simply as examples, and other suitable architectures may be implemented within the scope of the present disclosure.

### EXAMPLE COMPUTING DEVICE

FIG. 13 is a block diagram of an example computing device(s) 1300 suitable for use in implementing some embodiments of the present disclosure. Computing device 1300 may include an interconnect system 1302 that directly or indirectly couples the following devices: memory 1304, one or more central processing units (CPUs) 1306, one or more graphics processing units (GPUs) 1308, a communication interface 1310, input/output (I/O) ports 1312, input/output components 1314, a power supply 1316, one or more presentation components 1318 (e.g., display(s)), and one or more logic units 1320. In at least one embodiment, the computing device(s) 1300 may comprise one or more virtual machines (VMs), and/or any of the components thereof may comprise virtual components (e.g., virtual hardware components). For non-limiting examples, one or more of the GPUs 1308 may comprise one or more vGPUs, one or more of the CPUs 1306 may comprise one or more vCPUs, and/or one or more of the logic units 1320 may comprise one or more virtual logic units. As such, a computing device(s) 1300 may include discrete components (e.g., a full GPU dedicated to the computing device 1300), virtual components (e.g., a portion of a GPU dedicated to the computing device 1300), or a combination thereof.

Although the various blocks of FIG. 13 are shown as connected via the interconnect system 1302 with lines, this is not intended to be limiting and is for clarity only. For example, in some embodiments, a presentation component 1318, such as a display device, may be considered an I/O component 1314 (e.g., if the display is a touch screen). As another example, the CPUs 1306 and/or GPUs 1308 may include memory (e.g., the memory 1304 may be representative of a storage device in addition to the memory of the GPUs 1308, the CPUs 1306, and/or other components). As such, the computing device of FIG. 13 is merely illustrative. Distinction is not made between such categories as “workstation,” “server,” “laptop,” “desktop,” “tablet,” “client device,” “mobile device,” “hand-held device,” “game console,” “electronic control unit (ECU),” “virtual reality system,” and/or other device or system types, as all are contemplated within the scope of the computing device of FIG. 13.

The interconnect system 1302 may represent one or more links or busses, such as an address bus, a data bus, a control bus, or a combination thereof. The interconnect system 1302 may include one or more bus or link types, such as an industry standard architecture (ISA) bus, an extended industry standard architecture (EISA) bus, a video electronics standards association (VESA) bus, a peripheral component interconnect (PCI) bus, a peripheral component interconnect express (PCIe) bus, and/or another type of bus or link. In some embodiments, there are direct connections between components. As an example, the CPU 1306 may be directly connected to the memory 1304. Further, the CPU 1306 may be directly connected to the GPU 1308. Where there is direct, or point-to-point connection between components, the interconnect system 1302 may include a PCIe link to carry out the connection. In these examples, a PCI bus need not be included in the computing device 1300.

The memory 1304 may include any of a variety of computer-readable media. The computer-readable media may be any available media that may be accessed by the computing device 1300. The computer-readable media may include both volatile and nonvolatile media, and removable and non-removable media. By way of example, and not limitation, the computer-readable media may comprise computer-storage media and communication media.

The computer-storage media may include both volatile and nonvolatile media and/or removable and non-removable media implemented in any method or technology for storage of information such as computer-readable instructions, data structures, program modules, and/or other data types. For example, the memory 1304 may store computer-readable instructions (e.g., that represent a program(s) and/or a program element(s), such as an operating system. Computer-storage media may include, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which may be used to store the desired information and which may be accessed by computing device 1300. As used herein, computer storage media does not comprise signals per se.

The computer storage media may embody computer-readable instructions, data structures, program modules, and/or other data types in a modulated data signal such as a carrier wave or other transport mechanism and includes any information delivery media. The term “modulated data signal” may refer to a signal that has one or more of its characteristics set or changed in such a manner as to encode information in the signal. By way of example, and not limitation, the computer storage media may include wired media such as a wired network or direct-wired connection, and wireless media such as acoustic, RF, infrared and other wireless media. Combinations of any of the above should also be included within the scope of computer-readable media.

The CPU(s) 1306 may be configured to execute at least some of the computer-readable instructions to control one or more components of the computing device 1300 to perform one or more of the methods and/or processes described herein. The CPU(s) 1306 may each include one or more cores (e.g., one, two, four, eight, twenty-eight, seventy-two, etc.) that are capable of handling a multitude of software threads simultaneously. The CPU(s) 1306 may include any type of processor, and may include different types of processors depending on the type of computing device 1300 implemented (e.g., processors with fewer cores for mobile devices and processors with more cores for servers). For example, depending on the type of computing device 1300, the processor may be an Advanced RISC Machines (ARM) processor implemented using Reduced Instruction Set Computing (RISC) or an x86 processor implemented using Complex Instruction Set Computing (CISC). The computing device 1300 may include one or more CPUs 1306 in addition to one or more microprocessors or supplementary co-processors, such as math co-processors.

In addition to or alternatively from the CPU(s) 1306, the GPU(s) 1308 may be configured to execute at least some of the computer-readable instructions to control one or more components of the computing device 1300 to perform one or more of the methods and/or processes described herein. One or more of the GPU(s) 1308 may be an integrated GPU (e.g., with one or more of the CPU(s) 1306 and/or one or more of the GPU(s) 1308 may be a discrete GPU. In embodiments, one or more of the GPU(s) 1308 may be a coprocessor of one or more of the CPU(s) 1306. The GPU(s) 1308 may be used by the computing device 1300 to render graphics (e.g., 3D graphics) or perform general purpose computations. For example, the GPU(s) 1308 may be used for General-Purpose computing on GPUs (GPGPU). The GPU(s) 1308 may include hundreds or thousands of cores that are capable of handling hundreds or thousands of software threads simultaneously. The GPU(s) 1308 may generate pixel data for output images in response to rendering commands (e.g., rendering commands from the CPU(s) 1306 received via a host interface). The GPU(s) 1308 may include graphics memory, such as display memory, for storing pixel data or any other suitable data, such as GPGPU data. The display memory may be included as part of the memory 1304. The GPU(s) 1308 may include two or more GPUs operating in parallel (e.g., via a link). The link may directly connect the GPUs (e.g., using NVLINK) or may connect the GPUs through a switch (e.g., using NVSwitch). When combined together, each GPU 1308 may generate pixel data or GPGPU data for different portions of an output or for different outputs (e.g., a first GPU for a first image and a second GPU for a second image). Each GPU may include its own memory, or may share memory with other GPUs.

In addition to or alternatively from the CPU(s) 1306 and/or the GPU(s) 1308, the logic unit(s) 1320 may be configured to execute at least some of the computer-readable instructions to control one or more components of the computing device 1300 to perform one or more of the methods and/or processes described herein. In embodiments, the CPU(s) 1306, the GPU(s) 1308, and/or the logic unit(s) 1320 may discretely or jointly perform any combination of the methods, processes and/or portions thereof. One or more of the logic units 1320 may be part of and/or integrated in one or more of the CPU(s) 1306 and/or the GPU(s) 1308 and/or one or more of the logic units 1320 may be discrete components or otherwise external to the CPU(s) 1306 and/or the GPU(s) 1308. In embodiments, one or more of the logic units 1320 may be a coprocessor of one or more of the CPU(s) 1306 and/or one or more of the GPU(s) 1308.

Examples of the logic unit(s) 1320 include one or more processing cores and/or components thereof, such as Data Processing Units (DPUs), Tensor Cores (TCs), Tensor Processing Units (TPUs), Pixel Visual Cores (PVCs), Vision Processing Units (VPUs), Graphics Processing Clusters (GPCs), Texture Processing Clusters (TPCs), Streaming Multiprocessors (SMs), Tree Traversal Units (TTUs), Artificial Intelligence Accelerators (AIAs), Deep Learning Accelerators (DLAs), Programmable Vision Accelerator (PVAs)—which may include one or more direct memory access (DMA) systems, one or more vision or vector processing units (VPUs), one or more pixel processing engines (PPEs)—e.g., including a 2D array of processing elements that each communicate north, south, east, and west with one or more other processing elements in the array, one or more decoupled accelerators or units (e.g., decoupled lookup table (DLUT) accelerators or units), etc., Vision Processing Units (VPUs), Optical Flow Accelerators (OFAs), Field Programmable Gate Arrays (FPGAs), Neuromorphic Chips, Quantum Processing Units (QPUs), Associative Process Units (APUs), Arithmetic-Logic Units (ALUs), Application-Specific Integrated Circuits (ASICs), Floating Point Units (FPUs), input/output (I/O) elements, peripheral component interconnect (PCI) or peripheral component interconnect express (PCIe) elements, and/or the like.

The communication interface 1310 may include one or more receivers, transmitters, and/or transceivers that allow the computing device 1300 to communicate with other computing devices via an electronic communication network, included wired and/or wireless communications. The communication interface 1310 may include components and functionality to allow communication over any of a number of different networks, such as wireless networks (e.g., Wi-Fi, Z-Wave, Bluetooth, Bluetooth LE, ZigBee, etc.), wired networks (e.g., communicating over Ethernet or InfiniBand), low-power wide—area networks (e.g., LoRaWAN, SigFox, etc.), and/or the Internet. In one or more embodiments, logic unit(s) 1320 and/or communication interface 1310 may include one or more data processing units (DPUs) to transmit data received over a network and/or through interconnect system 1302 directly to (e.g., a memory of) one or more GPU(s) 1308.

The I/O ports 1312 may allow the computing device 1300 to be logically coupled to other devices including the I/O components 1314, the presentation component(s) 1318, and/or other components, some of which may be built in to (e.g., integrated in) the computing device 1300. Illustrative I/O components 1314 include a microphone, mouse, keyboard, joystick, game pad, game controller, satellite dish, scanner, printer, wireless device, etc. The I/O components 1314 may provide a natural user interface (NUI) that processes air gestures, voice, or other physiological inputs generated by a user. In some instances, inputs may be transmitted to an appropriate network element for further processing. An NUI may implement any combination of speech recognition, stylus recognition, facial recognition, biometric recognition, gesture recognition both on screen and adjacent to the screen, air gestures, head and eye tracking, and touch recognition (as described in more detail below) associated with a display of the computing device 1300. The computing device 1300 may be include depth cameras, such as stereoscopic camera systems, infrared camera systems, RGB camera systems, touchscreen technology, and combinations of these, for gesture detection and recognition. Additionally, the computing device 1300 may include accelerometers or gyroscopes (e.g., as part of an inertia measurement unit (IMU)) that allow detection of motion. In some examples, the output of the accelerometers or gyroscopes may be used by the computing device 1300 to render immersive augmented reality or virtual reality.

The power supply 1316 may include a hard-wired power supply, a battery power supply, or a combination thereof. The power supply 1316 may provide power to the computing device 1300 to allow the components of the computing device 1300 to operate.

The presentation component(s) 1318 may include a display (e.g., a monitor, a touch screen, a television screen, a heads-up-display (HUD), other display types, or a combination thereof), speakers, and/or other presentation components. The presentation component(s) 1318 may receive data from other components (e.g., the GPU(s) 1308, the CPU(s) 1306, DPUs, etc.), and output the data (e.g., as an image, video, sound, etc.).

### EXAMPLE DATA CENTER

FIG. 14 illustrates an example data center 1400 that may be used in at least one embodiments of the present disclosure. The data center 1400 may include a data center infrastructure layer 1410, a framework layer 1420, a software layer 1430, and/or an application layer 1440.

As shown in FIG. 14, the data center infrastructure layer 1410 may include a resource orchestrator 1412, grouped computing resources 1414, and node computing resources (“node C.R.s”) 1416(1)-1416(N), where “N” represents any whole, positive integer. In at least one embodiment, node C.R.s 1416(1)-1416(N) may include, but are not limited to, any number of central processing units (CPUs) or other processors (including DPUs, accelerators, field programmable gate arrays (FPGAs), graphics processors or graphics processing units (GPUs), etc.), memory devices (e.g., dynamic read-only memory), storage devices (e.g., solid state or disk drives), network input/output (NW I/O) devices, network switches, virtual machines (VMs), power modules, and/or cooling modules, etc. In some embodiments, one or more node C.R.s from among node C.R.s 1416(1)-1416(N) may correspond to a server having one or more of the above-mentioned computing resources. In addition, in some embodiments, the node C.R.s 1416(1)-14161(N) may include one or more virtual components, such as vGPUs, vCPUs, and/or the like, and/or one or more of the node C.R.s 1416(1)-1416(N) may correspond to a virtual machine (VM).

In at least one embodiment, grouped computing resources 1414 may include separate groupings of node C.R.s 1416 housed within one or more racks (not shown), or many racks housed in data centers at various geographical locations (also not shown). Separate groupings of node C.R.s 1416 within grouped computing resources 1414 may include grouped compute, network, memory or storage resources that may be configured or allocated to support one or more workloads. In at least one embodiment, several node C.R.s 1416 including CPUs, GPUs, DPUs, and/or other processors may be grouped within one or more racks to provide compute resources to support one or more workloads. The one or more racks may also include any number of power modules, cooling modules, and/or network switches, in any combination.

The resource orchestrator 1412 may configure or otherwise control one or more node C.R.s 1416(1)-1416(N) and/or grouped computing resources 1414. In at least one embodiment, resource orchestrator 1412 may include a software design infrastructure (SDI) management entity for the data center 1400. The resource orchestrator 1412 may include hardware, software, or some combination thereof.

In at least one embodiment, as shown in FIG. 14, framework layer 1420 may include a job scheduler 1428, a configuration manager 1434, a resource manager 1436, and/or a distributed file system 1438. The framework layer 1420 may include a framework to support software 1432 of software layer 1430 and/or one or more application(s) 1442 of application layer 1440. The software 1432 or application(s) 1442 may respectively include web-based service software or applications, such as those provided by Amazon Web Services, Google Cloud and Microsoft Azure. The framework layer 1420 may be, but is not limited to, a type of free and open-source software web application framework such as Apache Spark™ (hereinafter “Spark”) that may use distributed file system 1438 for large-scale data processing (e.g., “big data”). In at least one embodiment, job scheduler 1428 may include a Spark driver to facilitate scheduling of workloads supported by various layers of data center 1400. The configuration manager 1434 may be capable of configuring different layers such as software layer 1430 and framework layer 1420 including Spark and distributed file system 1438 for supporting large-scale data processing. The resource manager 1436 may be capable of managing clustered or grouped computing resources mapped to or allocated for support of distributed file system 1438 and job scheduler 1428. In at least one embodiment, clustered or grouped computing resources may include grouped computing resource 1414 at data center infrastructure layer 1410. The resource manager 1436 may coordinate with resource orchestrator 1412 to manage these mapped or allocated computing resources.

In at least one embodiment, software 1432 included in software layer 1430 may include software used by at least portions of node C.R.s 1416(1)-1416(N), grouped computing resources 1414, and/or distributed file system 1438 of framework layer 1420. One or more types of software may include, but are not limited to, Internet web page search software, e-mail virus scan software, database software, and streaming video content software.

In at least one embodiment, application(s) 1442 included in application layer 1440 may include one or more types of applications used by at least portions of node C.R.s 1416(1)-1416(N), grouped computing resources 1414, and/or distributed file system 1438 of framework layer 1420. One or more types of applications may include, but are not limited to, any number of a genomics application, a cognitive compute, and a machine learning application, including training or inferencing software, machine learning framework software (e.g., PyTorch, TensorFlow, Caffe, etc.), and/or other machine learning applications used in conjunction with one or more embodiments.

In at least one embodiment, any of configuration manager 1434, resource manager 1436, and resource orchestrator 1412 may implement any number and type of self-modifying actions based on any amount and type of data acquired in any technically feasible fashion. Self-modifying actions may relieve a data center operator of data center 1400 from making possibly bad configuration decisions and possibly avoiding underutilized and/or poor performing portions of a data center.

The data center 1400 may include tools, services, software or other resources to train one or more machine learning models or predict or infer information using one or more machine learning models according to one or more embodiments described herein. For example, a machine learning model(s) may be trained by calculating weight parameters according to a neural network architecture using software and/or computing resources described above with respect to the data center 1400. In at least one embodiment, trained or deployed machine learning models corresponding to one or more neural networks may be used to infer or predict information using resources described above with respect to the data center 1400 by using weight parameters calculated through one or more training techniques, such as but not limited to those described herein.

In at least one embodiment, the data center 1400 may use CPUs, application-specific integrated circuits (ASICs), GPUs, FPGAs, and/or other hardware (or virtual compute resources corresponding thereto) to perform training and/or inferencing using above-described resources. Moreover, one or more software and/or hardware resources described above may be configured as a service to allow users to train or performing inferencing of information, such as image recognition, speech recognition, or other artificial intelligence services.

### EXAMPLE NETWORK ENVIRONMENTS

Network environments suitable for use in implementing embodiments of the disclosure may include one or more client devices, servers, network attached storage (NAS), other backend devices, and/or other device types. The client devices, servers, and/or other device types (e.g., each device) may be implemented on one or more instances of the computing device(s) 1300 of FIG. 13—e.g., each device may include similar components, features, and/or functionality of the computing device(s) 1300. In addition, where backend devices (e.g., servers, NAS, etc.) are implemented, the backend devices may be included as part of a data center 1400, an example of which is described in more detail herein with respect to FIG. 14.

Components of a network environment may communicate with each other via a network(s), which may be wired, wireless, or both. The network may include multiple networks, or a network of networks. By way of example, the network may include one or more Wide Area Networks (WANs), one or more Local Area Networks (LANs), one or more public networks such as the Internet and/or a public switched telephone network (PSTN), and/or one or more private networks. Where the network includes a wireless telecommunications network, components such as a base station, a communications tower, or even access points (as well as other components) may provide wireless connectivity.

Compatible network environments may include one or more peer-to-peer network environments—in which case a server may not be included in a network environment—and one or more client-server network environments—in which case one or more servers may be included in a network environment. In peer-to-peer network environments, functionality described herein with respect to a server(s) may be implemented on any number of client devices.

In at least one embodiment, a network environment may include one or more cloud-based network environments, a distributed computing environment, a combination thereof, etc. A cloud-based network environment may include a framework layer, a job scheduler, a resource manager, and a distributed file system implemented on one or more of servers, which may include one or more core network servers and/or edge servers. A framework layer may include a framework to support software of a software layer and/or one or more application(s) of an application layer. The software or application(s) may respectively include web-based service software or applications. In embodiments, one or more of the client devices may use the web-based service software or applications (e.g., by accessing the service software and/or applications via one or more application programming interfaces (APIs)). The framework layer may be, but is not limited to, a type of free and open-source software web application framework such as that may use a distributed file system for large-scale data processing (e.g., “big data”).

A cloud-based network environment may provide cloud computing and/or cloud storage that carries out any combination of computing and/or data storage functions described herein (or one or more portions thereof). Any of these various functions may be distributed over multiple locations from central or core servers (e.g., of one or more data centers that may be distributed across a state, a region, a country, the globe, etc.). If a connection to a user (e.g., a client device) is relatively close to an edge server(s), a core server(s) may designate at least a portion of the functionality to the edge server(s). A cloud-based network environment may be private (e.g., limited to a single organization), may be public (e.g., available to many organizations), and/or a combination thereof (e.g., a hybrid cloud environment).

The client device(s) may include at least some of the components, features, and functionality of the example computing device(s) 1300 described herein with respect to FIG. 13. By way of example and not limitation, a client device may be embodied as a Personal Computer (PC), a laptop computer, a mobile device, a smartphone, a tablet computer, a smart watch, a wearable computer, a Personal Digital Assistant (PDA), an MP3 player, a virtual reality headset, a Global Positioning System (GPS) or device, a video player, a video camera, a surveillance device or system, a vehicle, a boat, a flying vessel, a virtual machine, a drone, a robot, a handheld communications device, a hospital device, a gaming device or system, an entertainment system, a vehicle computer system, an embedded system controller, a remote control, an appliance, a consumer electronic device, a workstation, an edge device, any combination of these delineated devices, or any other suitable device.

The disclosure may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The disclosure may be practiced in a variety of system configurations, including hand-held devices, consumer electronics, general-purpose computers, more specialty computing devices, etc. The disclosure may also be practiced in distributed computing environments where tasks are performed by remote-processing devices that are linked through a communications network.

As used herein, a recitation of “and/or” with respect to two or more elements should be interpreted to mean only one element, or a combination of elements. For example, “element A, element B, and/or element C” may include only element A, only element B, only element C, element A and element B, element A and element C, element B and element C, or elements A, B, and C. In addition, “at least one of element A or element B” may include at least one of element A, at least one of element B, or at least one of element A and at least one of element B. Further, “at least one of element A and element B” may include at least one of element A, at least one of element B, or at least one of element A and at least one of element B.

The subject matter of the present disclosure is described with specificity herein to meet statutory requirements. However, the description itself is not intended to limit the scope of this disclosure. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

### EXAMPLE PARAGRAPHS

A: One or more processors comprising: processing circuitry to generate one or more responses to one or more prompts based at least on a language model processing first data corresponding to the one or more prompts and second data corresponding to a steering input, wherein the steering input is generated or selected based at least on user-selections to a user interface that indicate steering preferences for the language model with respect to one or more categories of content.
B: The one or more processors of claim 18, wherein the steering input includes a steering vector that adjusts one or more internal activations of the language model during the processing of the first data corresponding to the one or more prompts.
C: The one or more processors of claim 18, wherein the one or more processors are comprised in at least one of: a control system for an autonomous or semi-autonomous machine; a perception system for an autonomous or semi-autonomous machine; a system for performing one or more simulation operations; a system for performing one or more digital twin operations; a system for performing one or more light transport simulation; a system for performing collaborative content creation for 3D assets; a system for performing one or more wireless cellular transmissions using a wireless cellular network; a system that provides one or more cloud gaming applications; a system for performing one or more deep learning operations; a system implemented using an edge device; a system implemented using a robot; a system for performing one or more generative AI operations; a system for performing one or more conversational AI operations; a system for performing operations using one or more large language models (LLMs); a system for performing operations using one or more vision language models (VLMs); a system for performing operations using one or more multi-modal language models (MMLMs); a system for performing operations using one or more vision-language-action (VLA) models; a system for performing one or more conversational AI operations; a system for performing one or more synthetic data generation operations; a system for presenting at least one of virtual reality content, augmented reality content, or mixed reality content; systems using or deploying one or more inference microservices; systems that incorporate deploy one or more machine learning models in a service or microservice along with an OS-level virtualization package (e.g., a container); a system incorporating one or more virtual machines (VMs); a system implemented at least partially in a data center; or a system implemented at least partially using cloud computing resources.
D: A method comprising: providing, to one or more user devices, a user interface associated with steering a model; receiving, via the user interface, a request to generate a category for steering content of the model, the request including at least one or more first inputs associated with a non-compliant state corresponding to the category and one or more second inputs associated with a compliant state corresponding to the category; generating, using the model and based at least on the one or more first inputs and the one or more second inputs, one or more steering vectors associated with steering the model with respect to the category; and storing, in one or more databases, the one or more steering vectors in association with the category.
E: The method of claim 1, wherein the generating the one or more steering vectors comprises: obtaining, based at least on the model processing the one or more first inputs, one or more first outputs associated with the non-compliant state; obtaining, based at least on the model processing the one or more second inputs, one or more second outputs associated with the compliant state; and generating the one or more steering vectors based at least on the one or more first outputs and the one or more second outputs.
F: The method of claim 2, wherein: the one or more first outputs include one or more first activations associated with one or more neural layers of the model processing the one or more first inputs; and the one or more second outputs include one or more second activations associated with the one or more layers of the model processing the one or more second inputs.
G: The method of claim 1, further comprising: receiving a third input from a second user device; generating, using the model and based at least on the third input and the one or more steering vectors, a compliant output associated with the category; and providing the compliant output to the second user device.
H: The method of claim 4, wherein the generating the compliant output comprises: determining, based at least on the model processing the third input, one or more outputs associated with the model; determining that the one or more outputs correspond to the non-compliant state; generating, based at least on the one or more outputs corresponding to the non-compliant state, one or more updated outputs using the one or more steering vectors; and generating, using the model and based at least on the one or more updated outputs, the compliant output associated with the category.
I: The method of claim 1, further comprising: receiving, from the one or more user devices, input data representative of a level of steering associated with the category; and updating the one or more steering vectors to generate one or more updated steering vectors associated with the level of steering.
J: The method of claim 6, wherein the level of steering comprises at least one of: a first level of steering associated with suppressing a type of content associated with the category; a second level of steering associated with increasing the type of content associated with the category; or a third level of steering that is between the first level of steering and the second level of steering.
K: A system comprising: one or more processors to: receive, from one or more user devices, input data indicating one or more preferences associated with steering a model with respect to one or more categories; obtain, based at least on the input data, one or more steering inputs associated with the one or more categories; and using the one or more steering inputs to modify processing of at least one input provided to the model that is associated with at least one category of the one or more categories.
L: The system of claim 8, wherein the one or more processors are further to: provide, to the one or more user devices, a user interface associated with steering the model with regard to a plurality of categories, wherein the input data is received based at least on one or more selections of the one or more categories using the user interface.
M: The system of claim 8, wherein: the input data further represents a level of steering associated with the one or more categories; the one or more processors are further to update the one or more steering inputs to generate one or more updated steering inputs that are associated with the level of steering; and the using the one or more steering inputs includes using the one or more updated steering inputs.
N: The system of claim 10, wherein the level of steering comprises at least one of: a first level of steering associated with suppressing a type of content; a second level of steering associated with increasing the type of; or a third level of steering that is between the first level of steering and the second level of steering.
O: The system of claim 10, wherein: the one or more steering inputs are associated with one or more first values; and the one or more steering inputs are updated by at least updating, based at least on the level of steering, the one or more first values to include one or more second values associated with the one or more updated steering inputs.
P: The system of claim 8, wherein the one or more processors are further to: store data representative of the one or more steering inputs in association with a user profile, wherein the one or more steering inputs are further obtained based at least on the user profile.
Q: The system of claim 8, wherein the using the one or more steering inputs to modify the processing of at least one input comprises: determining, based at least on the model processing the at least one input, one or more intermediate outputs associated with the model; determining that the one or more intermediate outputs correspond to non-compliant content associated with the category; generating, based at least on the one or more intermediate outputs corresponding to the non-compliant content, one or more updated intermediate outputs using the one or more steering inputs; and generating, using the model and based at least on the one or more updated intermediate outputs, compliant content associated with the at least one category.
R: The system of claim 8, wherein the one or more processors are further to: receive, from the one or more user devices, one or more non-compliant inputs associated with the one or more categories and one or more compliant inputs associated with the one or more categories; and generate, using the model and based at least on the one or more non-compliant inputs and the one or more compliant inputs, the one or more steering inputs associated with the one or more categories.
S: The system of claim 15, wherein the generation of the one or more steering inputs comprises: obtaining, based at least on the model processing the one or more non-compliant inputs, one or more first outputs; obtaining, based at least on the model processing the one or more compliant inputs, one or more second outputs; and generating, based at least on the one or more first outputs and the one or more second outputs, the one or more steering inputs associated with the one or more categories.
T: The system of claim 8, wherein the category comprises at least one of: a hate content category; a sexual content category; a harassing content category; a violent content category; a profane content category; a self-harm content category; a threat content category; a minor-directed content category; an illegal weapon content category; a controlled substance content category; a criminal content category; a privacy content category; a misinformation content category; a fraudulent content category; an intellectual property-infringing content category; a plagiarism content category; a biological harm content category; a malware content category; a jailbreak content category; a product or services content category; an off-topic content category; a bias content category; a contextual content category; or a hallucination content category.

What is claimed is:

1. A method comprising:
providing, to one or more user devices, a user interface associated with steering a model;
receiving, via the user interface, a request to generate a category for steering content of the model, the request including at least one or more first inputs associated with a non-compliant state corresponding to the category and one or more second inputs associated with a compliant state corresponding to the category;
generating, using the model and based at least on the one or more first inputs and the one or more second inputs, one or more steering vectors associated with steering the model with respect to the category; and
storing, in one or more databases, the one or more steering vectors in association with the category.

2. The method of claim 1, wherein the generating the one or more steering vectors comprises:
obtaining, based at least on the model processing the one or more first inputs, one or more first outputs associated with the non-compliant state;
obtaining, based at least on the model processing the one or more second inputs, one or more second outputs associated with the compliant state; and
generating the one or more steering vectors based at least on the one or more first outputs and the one or more second outputs.

3. The method of claim 2, wherein:
the one or more first outputs include one or more first activations associated with one or more neural layers of the model processing the one or more first inputs; and
the one or more second outputs include one or more second activations associated with the one or more layers of the model processing the one or more second inputs.

4. The method of claim 1, further comprising:
receiving a third input from a second user device;
generating, using the model and based at least on the third input and the one or more steering vectors, a compliant output associated with the category; and
providing the compliant output to the second user device.

5. The method of claim 4, wherein the generating the compliant output comprises:
determining, based at least on the model processing the third input, one or more outputs associated with the model;
determining that the one or more outputs correspond to the non-compliant state;
generating, based at least on the one or more outputs corresponding to the non-compliant state, one or more updated outputs using the one or more steering vectors; and
generating, using the model and based at least on the one or more updated outputs, the compliant output associated with the category.

6. The method of claim 1, further comprising:
receiving, from the one or more user devices, input data representative of a level of steering associated with the category; and
updating the one or more steering vectors to generate one or more updated steering vectors associated with the level of steering.

7. The method of claim 6, wherein the level of steering comprises at least one of:
a first level of steering associated with suppressing a type of content associated with the category;
a second level of steering associated with increasing the type of content associated with the category; or
a third level of steering that is between the first level of steering and the second level of steering.

8. A system comprising:
one or more processors to:
receive, from one or more user devices, input data indicating one or more preferences associated with steering a model with respect to one or more categories;
obtain, based at least on the input data, one or more steering inputs associated with the one or more categories; and
using the one or more steering inputs to modify processing of at least one input provided to the model that is associated with at least one category of the one or more categories.

9. The system of claim 8, wherein the one or more processors are further to:
provide, to the one or more user devices, a user interface associated with steering the model with regard to a plurality of categories,
wherein the input data is received based at least on one or more selections of the one or more categories using the user interface.

10. The system of claim 8, wherein:
the input data further represents a level of steering associated with the one or more categories;
the one or more processors are further to update the one or more steering inputs to generate one or more updated steering inputs that are associated with the level of steering; and
the using the one or more steering inputs includes using the one or more updated steering inputs.

11. The system of claim 10, wherein the level of steering comprises at least one of:
a first level of steering associated with suppressing a type of content;
a second level of steering associated with increasing the type of; or
a third level of steering that is between the first level of steering and the second level of steering.

12. The system of claim 10, wherein:
the one or more steering inputs are associated with one or more first values; and
the one or more steering inputs are updated by at least updating, based at least on the level of steering, the one or more first values to include one or more second values associated with the one or more updated steering inputs.

13. The system of claim 8, wherein the one or more processors are further to:
store data representative of the one or more steering inputs in association with a user profile,
wherein the one or more steering inputs are further obtained based at least on the user profile.

14. The system of claim 8, wherein the using the one or more steering inputs to modify the processing of at least one input comprises:
determining, based at least on the model processing the at least one input, one or more intermediate outputs associated with the model;
determining that the one or more intermediate outputs correspond to non-compliant content associated with the category;
generating, based at least on the one or more intermediate outputs corresponding to the non-compliant content, one or more updated intermediate outputs using the one or more steering inputs; and
generating, using the model and based at least on the one or more updated intermediate outputs, compliant content associated with the at least one category.

15. The system of claim 8, wherein the one or more processors are further to:
receive, from the one or more user devices, one or more non-compliant inputs associated with the one or more categories and one or more compliant inputs associated with the one or more categories; and
generate, using the model and based at least on the one or more non-compliant inputs and the one or more compliant inputs, the one or more steering inputs associated with the one or more categories.

16. The system of claim 15, wherein the generation of the one or more steering inputs comprises:
obtaining, based at least on the model processing the one or more non-compliant inputs, one or more first outputs;
obtaining, based at least on the model processing the one or more compliant inputs, one or more second outputs; and
generating, based at least on the one or more first outputs and the one or more second outputs, the one or more steering inputs associated with the one or more categories.

17. The system of claim 8, wherein the category comprises at least one of:
a hate content category;
a sexual content category;
a harassing content category;
a violent content category;
a profane content category;
a self-harm content category;
a threat content category;
a minor-directed content category;
an illegal weapon content category;
a controlled substance content category;
a criminal content category;
a privacy content category;
a misinformation content category;
a fraudulent content category;
an intellectual property-infringing content category;
a plagiarism content category;
a biological harm content category;
a malware content category;
a jailbreak content category;
a product or services content category;
an off-topic content category;
a bias content category;
a contextual content category; or
a hallucination content category.

18. One or more processors comprising:
processing circuitry to generate one or more responses to one or more prompts based at least on a language model processing first data corresponding to the one or more prompts and second data corresponding to a steering input, wherein the steering input is generated or selected based at least on user-selections to a user interface that indicate steering preferences for the language model with respect to one or more categories of content.

19. The one or more processors of claim 18, wherein the steering input includes a steering vector that adjusts one or more internal activations of the language model during the processing of the first data corresponding to the one or more prompts.

20. The one or more processors of claim 18, wherein the one or more processors are comprised in at least one of:
a control system for an autonomous or semi-autonomous machine;
a perception system for an autonomous or semi-autonomous machine;
a system for performing one or more simulation operations;
a system for performing one or more digital twin operations;
a system for performing one or more light transport simulation;
a system for performing collaborative content creation for 3D assets;
a system for performing one or more wireless cellular transmissions using a wireless cellular network;
a system that provides one or more cloud gaming applications;
a system for performing one or more deep learning operations;
a system implemented using an edge device;
a system implemented using a robot;
a system for performing one or more generative AI operations;
a system for performing one or more conversational AI operations;
a system for performing operations using one or more large language models (LLMs);
a system for performing operations using one or more vision language models (VLMs);
a system for performing operations using one or more multi-modal language models (MMLMs);
a system for performing operations using one or more vision-language-action (VLA) models;
a system for performing one or more conversational AI operations;
a system for performing one or more synthetic data generation operations;
a system for presenting at least one of virtual reality content, augmented reality content, or mixed reality content;
systems using or deploying one or more inference microservices;
systems that incorporate deploy one or more machine learning models in a service or microservice along with an OS-level virtualization package (e.g., a container);
a system incorporating one or more virtual machines (VMs);
a system implemented at least partially in a data center; or
a system implemented at least partially using cloud computing resources.
